(19) United States
(12) Patent Application Publication
(10) Pub. No.: US 2008/0305806 A1
(43) Pub. Date: Dec. 11, 2008

(54) CONTEXT ASSOCIATING ASPECTS

(75) Inventors: Edward K.Y. Jung, Bellevue, WA (US); Eric C. Leuthardt, St. Louis, MO (US); Royce A. Levien, Lexington, MA (US); Robert W. Lord, Seattle, WA (US); Mark A. Malamud, Seattle, WA (US); John D. Rinaldo, JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the Sate of Delaware

(21) Appl. No.: 11/899,987

(22) Filed: Sep. 7, 2007

Related U.S. Application Data
(63) Continuation-in-part of application No. 11/811,868, filed on Jun. 11, 2007.

(51) Int. Cl. H04Q 7/20

(52) U.S. Cl. 455/456.1

(57) ABSTRACT

One aspect relates to associating an at least one identifiable person and/or identifiable communication device with an at least one context at least partially by specifying an at least one context designated destination that designates the at least one identifiable person and/or identifiable communication device based at least partially on the at least one context.

### TECHNICAL FIELD

Certain aspects of this disclosure can relate to, but are not limited to, communications, as well as associated mechanisms and/or techniques.

### BRlEF DESCRIPTION OF THE FIGURES

FIG. 1 is a block diagram of one embodiment of a context designated destination communication system;

FIG. 2 is a block diagram of another embodiment of the context designated destination communication system;

FIG. 3 is a diagram of one embodiment of a packet such as can be used for communication (e.g., storing, transferring, and/or processing information, data, etc.) within the context designated destination communication system;

FIG. 4 is a diagram of another embodiment of the packet such as can be used for communication (e.g., storing, transferring, and/or processing information, data, etc.) within the context designated destination communication system;

FIG. 5 is a diagram of an embodiment of a context hierarchy of the context designated destination communication system of FIGS. 1 and/or 2;

FIG. 6 is a diagram of another embodiment of a context hierarchy of the context designated destination communication system of FIGS. 1 and/or 2;

FIG. 7 is a diagram of an embodiment of a context associator of the context designated destination communication system of FIGS. 1 and/or 2;

FIG. 8 is a diagram of one embodiment of a context associator of the context designated destination communication system of FIGS. 1 and/or 2;

FIG. 9 is a diagram of a flow chart such as may be utilized in certain embodiments of the context associator;

FIG. 10 is a diagram of an embodiment of the context associator;

FIG. 11 is a diagram of an embodiment of the context associator;

FIG. 12 (including FIGS. 12a, 12b, 12c, 12d, and/or 12e) is a flow chart of an embodiment of the context designated destination communication system as can be performed by FIGS. 1, 2, and other locations through this disclosure; and

FIG. 13 is a diagram, in tabular form, of an embodiment of the context designated destination registry, as described with respect to FIGS. 1 and 2.

### DETAILED DESCRIPTION

At least certain portions of the text of this disclosure (e.g., claims and/or detailed description and/or drawings as set forth herein) can support various different claim groupings and/or various different applications. Although, for sake of convenience and understanding, the detailed description can include section headings that generally track various different concepts associated with claims or general concepts contained therein. The detailed description is not intended to limit the scope of the invention as set forth by each particular claim. It is to be understood that support for the various applications or portions thereof thereby can appear throughout the text and/or drawings at one or more locations, irrespective of the section headings.

### 1. Certain Embodiments of a Context Designated Destination Communication Mechanism

This disclosure describes a variety of embodiments of the context designated destination communication system 100, which may be configured to include a variety of communication mechanisms, systems, and/or techniques such as can utilize a variety of movable or fixed phone systems, cell phones, satellite phones, computer networks, music and/or audio providing devices (such as IPODs), telecommunication devices, etc. Certain embodiments of the context designated destination communication system 100 can be configured such that a number of persons and/or devices can attempt to communicate with each other based at least partially on at least one context. Certain embodiments of the context designated destination communication system 100 can operate such as by designating the context based at least partially on a designated destination, etc. of a particular or suitable person and/or a particular device. As such, certain embodiments of the context-based information that can be directed to-based at least partially on a context designated destination, such as to be based at least partially on the at least one context of the person and/or at least one context of the device.

Certain embodiments of the context designated destination communication system 100 may thereby be configured as communication mechanisms or systems, such as computers, electronic-based devices, hardware-based devices, firmware-based devices, software-based devices, or other devices or combinations thereof such as may at least partially utilize hardware, software, and/or firmware, or combination thereof can be configured to attempt to establish a communication. Such attempts to establish a communication can therefore be based, at least in part, on a context of the person and/or the at least one context of the device as at least partially determined based on the context designated destination. Attempts to establish communication, or establishing communication with (to and/or from) at least one other desired device, person, or system with the context designated destination communication system 100 that are based at least partially on at least one context can be particularly desirable when the interfacing system, persons, and/or devices is remote from, does not have access to, or does not desire to use at least one of: a phone book (manual and/or electronic), a lookup table (manual and/or electronic), a directory (manual and/or electronic), and/or an operator assistance mechanism (manual and/or electronic), etc.

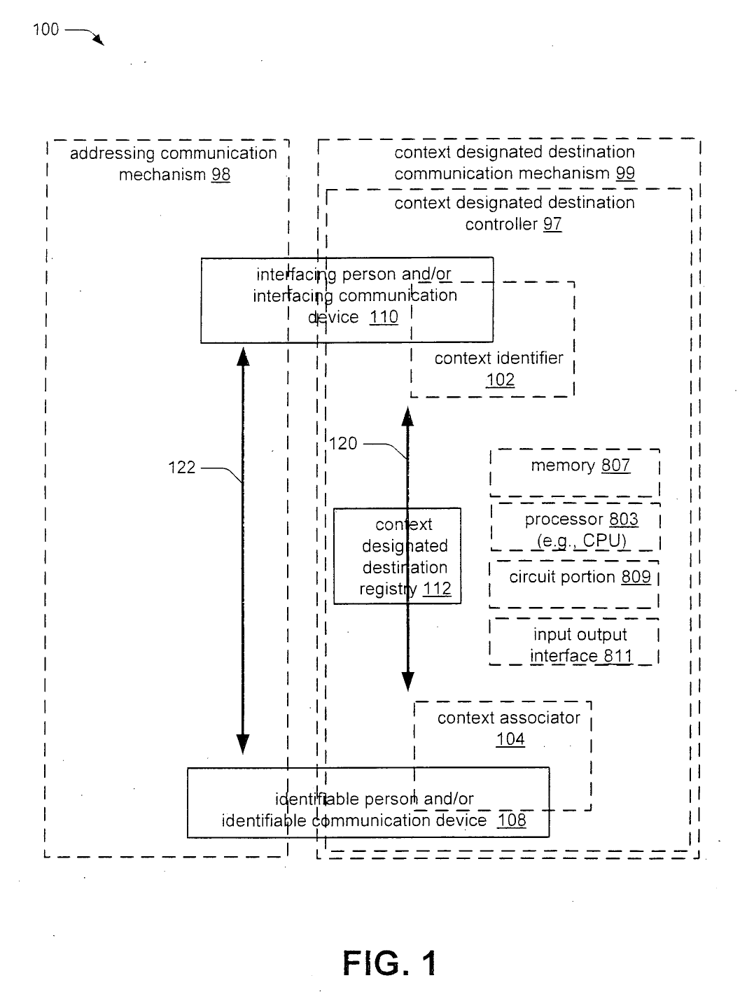

This disclosure describes a variety of embodiments, as well as a variety of associated techniques, pertaining to certain embodiments of the context designated destination communication system 100, as described in block form with respect to FIGS. 1 and/or 2. Certain examples of embodiments of the context designated destination communication system 100 can include, but are not limited to, an at least one context designated destination communication mechanism 99, an at least one interfacing person and/or interfacing communication device 110, an at least one context designated destination registry 112, an at least one identifiable person and/or identifiable communication device 108, and/or optionally an at least one addressing communication mechanism 98.

Certain embodiments of the at least one context designated destination communication system 100 can include the at least one context designated destination registry 112, as described with respect to FIG. 13, such that a variety of persons, corporations, organizations, entities, etc. can be communicated with based at least partially based on a context. As such, the participating ones of the at least one identifiable person and/or identifiable communication device 108 can be communicated with using the techniques as described in this disclosure.

Certain embodiments of the identifiable person and/or identifiable communication device 108 can be configured structurally and/or operationally similar as certain embodiments of the interfacing person and/or interfacing communication device 110. Either or both of the at least one interfacing person and/or interfacing communication device 110 and/or the at least one identifiable person and/or identifiable communication device 108 may be operationally aware or may be operationally unaware of whether a particular communication is being made via the addressing communication mechanism 98 and/or the context designated destination communication mechanism 99. Certain embodiments of the interfacing person and/or interfacing communication device 110 can, depending upon application, include those communication devices that can attempt to communicate with and/or can communicate with certain embodiments of the identifiable person and/or identifiable communication device 108. Following the initial communication and/or attempt to communicate, such as a setting-up signal or a ringer signal, both communication devices 110 and 108 can thereupon communicate with each other in a manner (e.g., either uniplex or duplex) depending upon such factors as application, configuration, embodiment, and/or as desired.

This disclosure provides a number of alternative designated destination techniques between certain embodiments of the at least one interfacing person and/or interfacing communication device 110 and certain embodiments of the at least one identifiable person and/or identifiable communication device 108. Certain embodiments of the context designated destination communication mechanism 99 can include the at least one context designated destination registry 112 that can provide for maintaining and/or retrieving a number of context designated destinations for each of the at least one identifiable person and/or identifiable communication device 108. Certain embodiments of the at least one context designated destination registry 112 can be configured to include software, hardware, firmware, electronic, and/or computer-based portions (e.g., and as such may be at least partially included in the context designated destination controller 97). Certain embodiments of the at least one context designated destination registry 112 may be configured to act and/or be configured, as a registrar (e.g., including a storage/retrieval device such as a- memory) that may translate or otherwise process data. Certain embodiments of the at least one context designated destination registrar 112 may thus facilitate communications (or attempted communications) between at least one of the interfacing person and/or interfacing communication device 110 and at least one of the identifiable person and/or identifiable communication device 108.

Certain embodiments of the context designated destination registry 112 can operate such as by translating a variety of context-based communications to establish or maintain context-based communications (such as utilized by certain embodiments of the at least one context designated destination communication mechanism 99). The context designated destination registry 112 may thereby be useful when using conventional addressed-based embodiments of the at least one interfacing person and/or interfacing communication device 110 (e.g., with conventional address-based phone(s), conventional address-based communication device(s), conventional address-based data transfer device(s), etc). By comparison, certain embodiments of the at least one interfacing person and/or interfacing communication device 110 and certain embodiments of the at least one identifiable person and/or identifiable communication device 108 can be configured to provide address-based communications via certain embodiments of the addressing communication mechanism 98. Certain embodiments of the at least one interfacing person and/or interfacing communication device 110 and certain embodiments of the at least one identifiable person and/or identifiable communication device 108 can therefore provide context-based communications via certain embodiments of the at least one context designated destination communication mechanism 99.

As such, certain embodiments of the at least one interfacing person and/or interfacing communication device 110 and the at least one identifiable person and/or identifiable communication device 108 can establish or maintain communications utilizing context-based techniques. Certain embodiments of the identifiable person and/or identifiable communication device 108 and/or the interfacing person and/or interfacing communication device 110 may therefore operate over conventional networks and/or communication systems, or alternately over those networks and/or communication systems that are configured, designed, and/or adapted to operate as certain embodiments of the context designated destination communication system 100.

Certain conventional devices such as cell phones, land-line phones, satellite phones, PDAs, music and/or audio providing devices such as IPODs, computers, laptop computers, videoconferencers, image transmitting devices, data transmitting devices, optical devices, cameras, computer devices, fax machines, etc. can be configured either as the interfacing person and/or interfacing communication device 110 and/or the identifiable person and/or identifiable communication device 108. Certain embodiments of the at least one interfacing person and/or interfacing communication device 110 and/or the at least one identifiable person and/or identifiable communication device 108 can include at least one of a telephone, a computer, a music and/or audio providing device such as IPODs, a communication device, a PDA, a cell phone, a satellite phone, etc.

Certain embodiments of the context designated destination communication system 100 can thereby be configured to provide communications or attempted communications via one more of the at least one context designated destination communication mechanism 99 and/or at least one addressing communication mechanism 98 between one or more of the at least one interfacing person and/or interfacing communication device 110 and/or the at least one identifiable person and/or identifiable communication device 108. A number of embodiments of context designated destination are described in this disclosure can include at least some information, data, etc. that may be used to determine which identifiable communication device(s) 108 can, at a given time, communicate with certain of the at least one interfacing communication device(s) 110. Such communication and/or attempted communication can therefore be based at least partially, on context of the at least one identifiable person and/or identifiable communication device 108, as associated using certain embodiments of the context designated destination. As such, certain embodiments of the context designated destination can be at least partially included in and/or associated with the at least one interfacing person and/or interfacing communication device 110, the context designated destination communication mechanism 99, and/or the at least one identifiable person and/or identifiable communication device 108.

Certain embodiments of the context designated destination communication system 100 can be configured to respond to one, or more, persons that may be in an emergency, hazard, warning, alert, or other such situation. Consider, for example, the instance of hurricanes, floods, diseases, epidemics, emergencies, wars, etc. where it may be highly desirable or essential to contact certain people within certain regions quickly, perhaps even people traveling in vehicles traveling within certain roadways, regions of airspace, waterways, etc. Certain embodiments of the context designated destination communication system 100 could allow communications with one, a number of, or numerous people based at least partially on the context of the people being situated within or nearby the context-specified location. Certain embodiments of the context within certain embodiments of the context designated destination communication system 100 can be equated to the techniques by which at least one interfacing person and/or interfacing communication device 110 utilize to attempt to communicate with, or communicate with, the at least one identifiable person and/or identifiable communication device 108.

Certain embodiments of the context designated destination communication system 100 can be configured to provide civilian as well as military communications. The Military does represent a large organization which is challenged by efficient logistics of material as well as personnel. Certain embodiments of the context designated destination communication system 100 can be configured to provide both military and civilian communication and/or data transfer (encrypted, private, public, and other). FIGS. 1 and/or 2 illustrate one or more respective communication pathways (such as indicated by arrows 120 and/or 122) within certain embodiments of the context designated destination communication system 100. Certain embodiments of the communication pathways, as indicated by respective arrows 120 and/or 122, can be maintained respectively within certain embodiments of the at least one context designated destination communication mechanism 99, certain embodiments of the at least one addressing communication mechanism 98, and/or a combination thereof as described in this disclosure. Each communication pathway, as illustratively indicated by the arrows 120 and/or 122, can operationally extend between certain embodiments of the interfacing person and/or interfacing communication device 110, certain embodiments of the identifiable person and/or identifiable communication device 108 and/or a portion or combination thereof.

Certain embodiments of the context designated destination communication system 100 can also provide for such related operations (such as may be associated with communicating and/or attempting communication between the at least one communication device(s) 108 and/or 110) as logging on, maintaining, disconnecting, etc. It is also anticipated that certain embodiments of the context designated destination communication system 100 can provide for either user-provided or other-provided privacy concerns, such is not necessarily allowing each attempted communication to certain embodiments of the at least one identifiable person and/or identifiable communication device 108 to be effective.

Certain embodiments of an address-based communication pathway as indicated by arrow 122 can be configured to provide conventional communication between certain embodiments of the interfacing person and/or interfacing communication device 110 and certain embodiments of the identifiable person and/or identifiable communication device 108. As such, certain embodiments of the addressed-based communication pathway, as indicated by arrow 122, can be viewed as operationally and/or structurally similar to the current communication networks, telecommunication pathways, data-transfer pathways, communication pathways, etc. as generally understood in the telecommunication, communication, and/or computer technologies. For instance, certain of the interfacing person and/or interfacing communication device 110 (which may be cell phone, hard-line phone, music and/or audio providing devices such as IPODs, VOIP, PDA, etc.) can attempt to communicate with certain ones of the identifiable person and/or identifiable communication device 108 by dialing that particular identifiable communication device 108.

Certain embodiments of a context designated destination based communication pathway as indicated by arrow 120 can be configured to provide context-based communications between the interfacing person and/or interfacing communication device 110 and/or the identifiable person and/or identifiable communication device 108. Certain embodiments of a context designated destination based communication pathway as indicated by arrow 120 can utilize certain embodiments of the context designated destination registry 112 that can be configured to act as a registry. Certain embodiments of the context designated destination registrar 112 can effectively translate from a relatively ambiguous specification (e.g., the interfacing context as described with respect to FIG. 13) to a relatively precise specification (e.g., the identifiable context as described with respect to FIG. 13) as associated with a device address of the identifiable person and/or identifiable communication device 108. As such, certain embodiments of the context designated destination based communication pathway as indicated by arrow 120 can be configured to attempt communications and/or provide communication between certain of the interfacing person and/or interfacing communication device 110 and/or certain of the identifiable person and/or identifiable communication device 108 at least partially relying on the context. Examples of such context can include, but are not limited to, that criteria or set of criteria used such as during attempts to communicate with, for example: one or more persons and/or communication devices such as may be situated in a particular vehicle, that are situated in a particular department for a company or organization, situated nearby or within a particular physical structure, dwelling, or building, etc.

It is envisioned that certain embodiments of the context designated destination based communication pathways (as indicated by arrow 120) may utilize one or more of the identifiable person and/or identifiable communication device 108, at least one of the context designated destination registry 112, the context designated destination controller 97, and/or the interfacing person and/or interfacing communication device 110. Certain embodiments of the context designated destination based communication pathways as indicated by arrow 120 may be operationally, structurally, and/or functionally modified as compared with certain component of certain embodiments of the address based communication pathway, as indicated by arrow 122, as described in this disclosure.

One or more of either the at least one context designated destination communication mechanism 99 and/or the at least one addressing communication mechanism 98 can thereby control, maintain, and/or attempt communications within the context designated destination communication system 100, either based at least partially on a context and/or based at least partially on an addressing scheme. Within this disclosure, certain embodiments of the at least one addressing communication mechanism 98 can be configured to establish over the communication pathway, as indicated by the arrow 192, can thereby be viewed as providing a conventional communication modality.

Certain embodiments of the at least one identifiable person and/or identifiable communication device 108 and/or the at least one interfacing person and/or interfacing communication device 110 may each be configured substantially as conventional devices which can communicate with each other, at least partially utilizing either certain of the addressing communication mechanism 98 and/or certain of the context designated destination communication mechanism 99. As such, certain of the addressing communication mechanism 98 may be viewed as operating or being structured similar to as conventional or existing telecommunication, data-transfer, networking, computing, or other such systems that may actually include at least certain ones of the interfacing person and/or interfacing communication device 110 and/or the identifiable person and/or identifiable communication device 108.

Certain embodiments of the context designated destination communication mechanism 99 can be configured, considered, or viewed as a telecommunication system, data-transfer system, networking system, computer system, or other such systems being applied to in addition to, or alternative to, the addressing communication mechanism 98. Certain embodiments of the interfacing person and/or interfacing communication device 110 may include those devices that can specify at least one context designated destination, and thereby which indicates those contexts by which they can be associated.

Within this disclosure, certain embodiments of the attempting or establishing communications can be equated to mapping, similar to as described with respect to FIG. 13. Such mapping may be viewed, for example, as context matching, translating, and/or context associating between the interfacing context value and the identifiable context value. For example, attempting to establish and/or establishing communications within the context designated destination communication system 100 that is based at least partially on context, can be analogized to mapping of the communications between multiple mapped devices such as can effectively translate between the interfacing context value and the identifiable context value. Such mapped devices may include, but not limited to, the at least one of the at least one interfacing person and/or interfacing communication device 110 and/or the at least one identifiable person and/or identifiable communication device 108.

Certain embodiments of the context used during communicating or attempting to communicate with the at least one interfacing person and/or interfacing communication device 110 can be operationally associated with, but may not include, at least one context identifier 102. Certain embodiments of the context identifier 102 can be used by certain embodiments of the at least one interfacing person and/or interfacing communication device 110 to attempt to communicate with, or attempt to communicate with, at least one identifiable person and/or identifiable communication device 108 (or other of the interfacing person and/or interfacing communication device 110) based at least partially on the at least one particular context. Certain embodiments of the context identifier 102 can be used during an attempt to establish and/or maintain a communication between the at least one identifiable person and/or identifiable communication device 108 and/or another interfacing person and/or interfacing communication device 110. At least certain portions of certain embodiments of the context identifier 102 can be at least partially associated with, but exclusive of, the at least one interfacing person and/or interfacing communication device 110, such as may be the case with certain conventional communication device(s) (phone, computer, music and/or audio providing devices such as IPODs, etc.) being applied to certain embodiments of the context designated destination communication system 100.

More particularly, at least one context designated destination communication mechanism 99 can be configured such that at least portions of certain embodiments of the context identifier 102 can be at least partially associated with, but exclusive of, the at least one interfacing person and/or interfacing communication device 110. By comparison, at least portions of certain embodiments of the context identifier 102 can be at least partially integrated within or included within the at least one interfacing person and/or interfacing communication device 110, such as may be the case within various phones, computers, VOIP devices, music and/or audio providing devices, or other communication devices configured particularly to interface within the context designated destination communication system 100. The operation and configuration of certain exemplary embodiments of the context identifier 102 are described elsewhere in this disclosure.

Certain embodiments of the at least one identifiable person and/or identifiable communication device 108 can be configured to determine under which of the at least one context (e.g., circumstance, location, and/or situation) is being utilized to attempt to communicate and/or communicate at least partially utilizing certain embodiments of the context associator 104. Certain embodiments of the at least one context can be maintained and/or retrieved from certain embodiments of the at least one context designated destination registry 112. Certain embodiments of the at least one identifiable person and/or identifiable communication device 108 can thereby be associated with or include at least one context as a result of activity at least partially by at least one context associator 104. Certain embodiments of the context associator 104 can therefore be configured to determine, under which contexts and/or situations, the at least one interfacing person and/or interfacing communication device 110 can attempt to contact any of particular one of the at least one identifiable person and/or identifiable communication device 108.

Certain embodiments of the at least one context associator 104 can thereby be associated with the at least one identifiable person and/or identifiable communication device 108 in an attempt to determine those contexts, instances, and/or conditions by which at least particular ones of the at least one identifiable person and/or identifiable communication device 108 can be communicated with. At least certain portions of certain embodiments of the context associator 104 can be at least partially associated with, but may be exclusive of, the at least one identifiable person and/or identifiable communication device 108. This may occur in certain instances of certain conventional communication device(s) (e.g., phone(s), computer(s), music and/or audio providing devices, communication device(s), etc.) being applied to certain embodiments of the context designated destination communication system 100.

By comparison, at least certain portions of certain embodiments of the context associator 104 can be at least partially integrated within or included within the at least one identifiable person and/or identifiable communication device 108. This may be the instance with certain phones, computers, music and/or audio providing devices, and/or other communication devices configured particularly to interface within the context designated destination communication mechanism 99. The operation and configuration of certain exemplary, embodiments of the at least one context associator 104 are described elsewhere at various locations through this disclosure.

Certain embodiments of the at least one addressing communication mechanism 98 can be configured as a variety of networks or systems including but not limited to: a plain old telephone system (POTS), a telecommunication network or system, a communication network or system, a data-transfer network or system, a computer network or system, a Voice Over Internet Protocol (VOIP) network, etc. Certain embodiments of the at least one interfacing person and/or interfacing communication device 110 and/or the at least one identifiable person and/or identifiable communication device 108 can be configured to address, communicate, and/or operate over the at least one addressing communication mechanism 98 utilizing conventional addressing and/or communication modalities. Such conventional and/or modified addressing and/or communication modalities and/or techniques can be, for example, similar to those that are often utilized within existing communication, telecommunication, data-transfer, computer, and/or other networks. Certain communications between the at least one interfacing person and/or interfacing communication device 110 and/or at least one identifiable person and/or identifiable communication device 108 can therefore be via either of both of the at least one addressing communication mechanism 98 and/or the at least one context designated destination communication mechanism 99. Certain communications between the at least one interfacing person and/or interfacing communication device 110 and/or at least one identifiable person and/or identifiable communication device 108 can be based on and /or utilize conventional techniques and/or devices.

Within this disclosure, both the at least one interfacing person and/or interfacing communication device 110, as well as the at least one identifiable person and/or identifiable communication device 108, may, include either of or both the person as well as the communication device as an operationally associated entity depending on at least one context, as described in this disclosure. For example, while a communicating device may be configured to transfer data with another communicating device, it would likely be considered as the users (e.g., persons) associated with each communication device 108 and/or 110 are actually what is being considered as (intelligently) communicating. Within this disclosure, the communicating process may therefore actually be applied to either the persons, as well as the associated communicating device(s) 108 and/or 110.

Within this disclosure, certain embodiments of the at least one context designated destination communication mechanism 99 can be viewed as providing a context-based communication and/or addressing modality that can allow addressing and/or maintained communications between one or more of the at least one interfacing person and/or interfacing communication device 110 and/or the at least one identifiable person and/or identifiable communication device 108. Such communications within the at least one context designated destination communication mechanism 99 can be at least partially based on the context associated with the at least one identifiable person and/or identifiable communication device 108.

There may be a variety of communication techniques and/or modalities (or a plurality thereof) that can be utilized. For example, certain examples/embodiments of the at least one context designated destination communication mechanism 99 can be configured to utilize the layer structure, similar to the well-known Open Systems Interconnection Basic Reference Model (OSI Reference Model or OSI Model for short) as characterized by 7 layers. The OSI model (alternately known as the ISO model) is generally understood by those skilled in the communications, computer, networking, or similar technologies. Certain context-based communication, and/or addressing communication techniques can be maintained, established, and/or provided between one or more of the at least one identifiable person and/or identifiable communication device 108 and/or at least one interfacing person and/or interfacing communication device 110 based at least partially on the 7 layers of the OSI model. A considerable percentage of conventional computer networking, data-transfer, as well as telecommunication technologies rely on concepts of or derivatives of the OSI model. The OSI model is described in considerable detail in numerous text-books, as well as over the Internet, and may not be described in further detain in this disclosure. The OSI model is generally known and understood by those skilled in the computer, communication, telecommunication, data-transfer, and networking technologies. As telecommunications have become more sophisticated such as by being data-transfer related, as well as image transfer related, certain embodiments of the context designated destination communication system 100 may be considered as relying more on data transfer techniques, etc. during operation.

The embodiments of the context designated destination communication system 100, as described with respect to FIG. 1, illustrates at least one context designated destination communication mechanism 99 being separated and/or distinct from (e.g., functionally) the at least one addressing communication mechanism 98 such that each communication can be attempted and/or maintained either based on context or addressing.

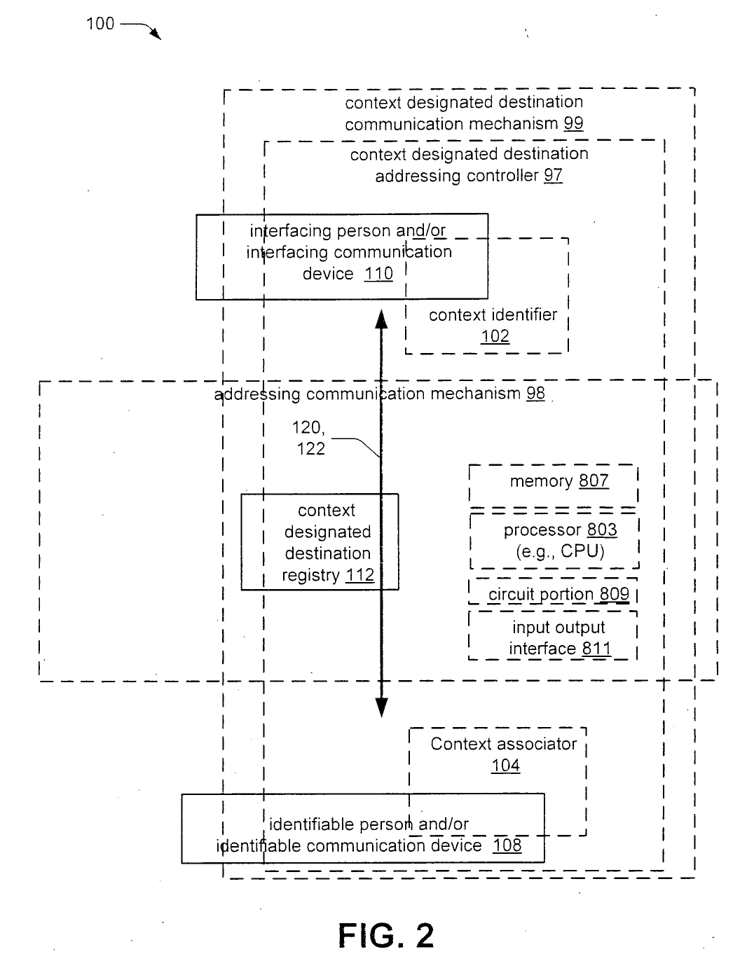

By comparison, at least a portion of certain embodiments of the context designated destination communication mechanism 99 can actually be operatively associated with and/or interact with at least a portion of certain embodiments of the addressing communication mechanism 98. As such, communications can be attempted and/or maintained between the at least one identifiable person and/or identifiable communication device 108 and the at least one interfacing person and/or interfacing communication device 110 using a combination of context techniques and/or addressing techniques. For example, FIG. 2 illustrates an embodiment of the context designated destination communication system 100 in which the context designated destination communication mechanism 99 can utilize certain embodiments of the context designated destination such as, for example, at least one layer (e.g., OSI-type as described in this disclosure) can be functionally or operationally structured on top of, below, or on the side of a conventional addressing mechanism such as may be configured as the addressing communication mechanism 98. The use of such layers and/or layered concepts are generally understood by those skilled with the OSI model, communications, telecommunications, data-transfer, networking concepts, etc. As such, certain embodiments of the context designated destination communication mechanism 99 can include, for example, at least one communication device, at least one look-up table, at least one directory, at least one database, etc. (or combination thereof) that can provide context functionally, and thereby allow certain embodiments of the at least one of the at least one interfacing person and/or interfacing communication device 110 to attempt to communicate with certain embodiments of the at least one identifiable person and/or identifiable communication device 108 via a combination of at least one context and/or their respective phone numbers, communication addresses, etc.

The particular configuration of the modules, portions, segments, devices, mechanisms, etc. of the context designated destination communication system 100, as described with respect to FIGS. 1 and 2, are intended to be illustrative in nature, but not limiting in scope. As such, the embodiments of the context designated destination communication system 100 could be configured differently while remaining within the intended scope of the present disclosure, based primarily on the scope of the appended claims.

Certain embodiments of the interfacing person and/or interfacing communication device 110 that are attempting to contact another person might be unaware of whether the communication is being conducted via the at least one context designated destination communication mechanism 99 or the addressing communication mechanism 98. As such, certain embodiments of the interfacing person and/or interfacing communication device 110 might be unaware of whether context is being used to establish the communication to the at least one identifiable person and/or identifiable communication device 108, or whether a conventional addressing mechanism is being used. For example, a user of a cell phone, satellite phone, land-line phone, computer, music and/or audio providing devices, or other communication device may actuate certain embodiments of the context designated destination communication system 100, or whether the communication being established is based on context or not. Consider that certain conventional cell, satellite, hard-wired, other phones, music and/or audio providing systems, telecommunication systems, data-transfer, and/or videoconferencers, etc. can be configured as an embodiment of the at least one interfacing person and/or interfacing communication device 110.

Certain instances of the communication is attempted by the interfacing person and/or interfacing communication device 110, certain embodiments of the at least one context designated destination communication mechanism 99 and/or identifiable person and/or identifiable communication device 108 can attempt, set-up, and/or maintain the communication based at least partially on context. Such context can be actuated, for example, by attempting a communication such as a phone call to a destination serviced by certain embodiments of the at least one context designated destination communication mechanism 99, by which at least one communication can be attempted or established to one or more of the identifiable person and/or identifiable communication device 108.

Certain examples/embodiments of the at least one context designated destination communication mechanism 99 can be configured to operate at a higher layer (e.g., within the OSI model) than the at least one addressing communication mechanism 98, by which communications are established, maintained, and/or provided via the at least one context designated destination communication mechanism 99. Certain embodiments of the at least one addressing communication mechanism 98 can be configured to operate within one or more of the lower layers of the OSI model (e.g., one or more of the physical, data link, network, and/or transport layers). Correspondingly, certain embodiments of the at least one context designated destination communication mechanism 99 can be configured to operate within upper layers of the OSI model (e.g., one or more of the application, presentation, session, transport, network, and/or data link layers). By comparison, various components and/or portions of the at least one context designated destination communication mechanism 99 can be configured to operate through a variety of layers of the OSI model. The OSI model is commonly used to model computer networking, which may be particularly utilized for certain computer-based are networking-based embodiments of the context designated destination communication system 100. By comparison, certain cell phone, telecommunication, music and/or audio providing devices, data-transfer, etc. which may utilize other embodiments that may be, in certain aspects, more operationally simple or complex as compared to the OSI model. Certain cell phone, telephone, telecommunication, data-transfer, and other communication techniques involving transferring police in additional manner (e.g., VOIP, Digital Subscriber Line (DSL), other Internet-based telephones, etc.) may also utilize OSI model type data transfer.

Within this disclosure, certain embodiments of the context designated destination communication system 100 are configured to utilize VOIP technology. In general, the term “VOIP” is often used to describe a specific “Voice Over Internet Protocol” in which telephone, voice, sound, data, image, audio, images, and/or other information may be transferred via the Internet. Within this disclosure, however, the term VOIP may, depending on application, refer to any known or derivative technique by which telephone, voice, sound, data, image, audio, and/or other information may be transferred over the Internet, a communication system, a telecommunication system, or other communication network.

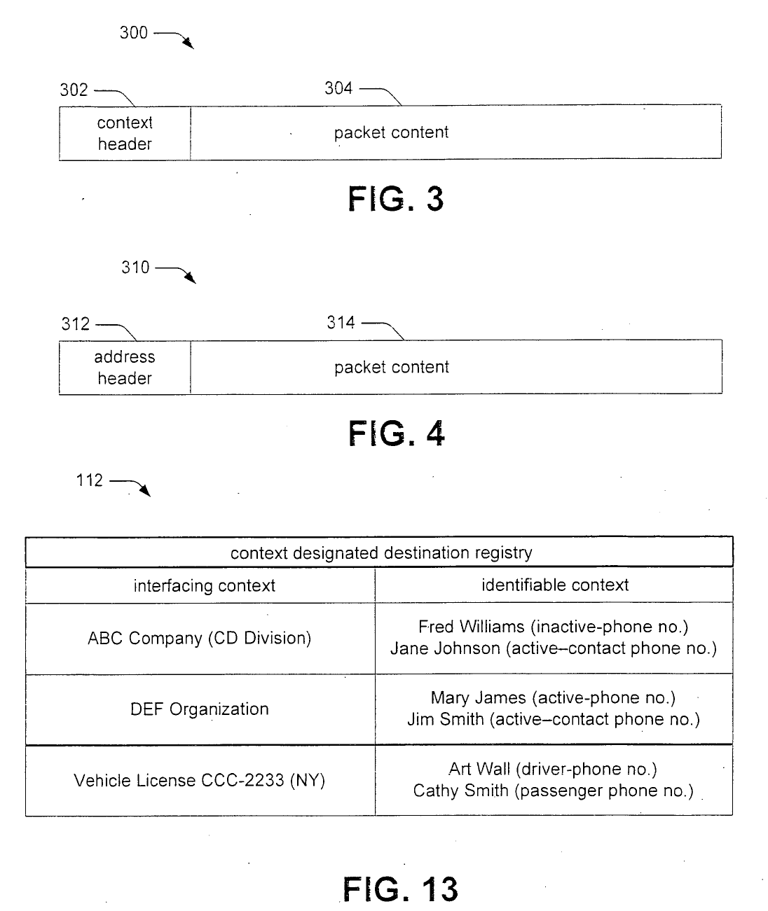

Certain embodiments of the context designated destination communication system 100 can also provide for packet-type transmission between the at least one interfacing person and/or interfacing communication device 110 and/or the at least one identifiable person and/or identifiable communication device 108. FIG. 3, for example, shows certain embodiments of a context-based packet 300 including a context designated destination portion or context header 302 and a body portion or packet content 304. The use of packets in the transmission of signals, information, data, etc. is generally well-known else not be further detailed in this disclosure. The body portion 304 is configured to include and/or transfer the information such as data that is being include within the packet 300. By comparison, certain embodiments of the context designated destination portion 302 can include information, such as data, that can indicate the context such may be actuated by certain embodiments of the at least one identifiable person and/or identifiable communication device 108. Within certain embodiments of the context designated destination communication system 100, for example, certain embodiments of the context-based packet 300 can be transferred along the context designated communication pathway as indicated by the arrow 120 as described within FIGS. 1 and/or 2.

By comparison, FIG. 4 shows an embodiment of an address-based packet 310 that include, but is not limited to, and address portion 312 and/or a body portion 314 certain embodiments of the body portion or packet content 314 can include the information, data, etc. can be transferred over a conventional networks, such as within certain embodiments of the addressing communication mechanism 98, the travel can be at least partially controlled based on an address included the address portion 312. Packet-type communications are generally known in the computer, communications, data-transfer, and/or telecommunications art, and will not be further described herein.

Certain embodiments of the at least one context designated destination registry 112, as described with respect to FIGS. 1 and 2, can be configured to convert the address portion 312 of certain embodiments of the address-based packet 310 (of FIG. 4) to/from the context header 302 of certain embodiments of the context-based packet 300 (of FIG. 3). Such conversion can be based at least partially on a context registrar as stored in the form of data, and can take the general form of, for example, translating between a relatively ambiguous specification to a relatively precise specification as associated with a device address of the identifiable person and/or identifiable communication device 108.

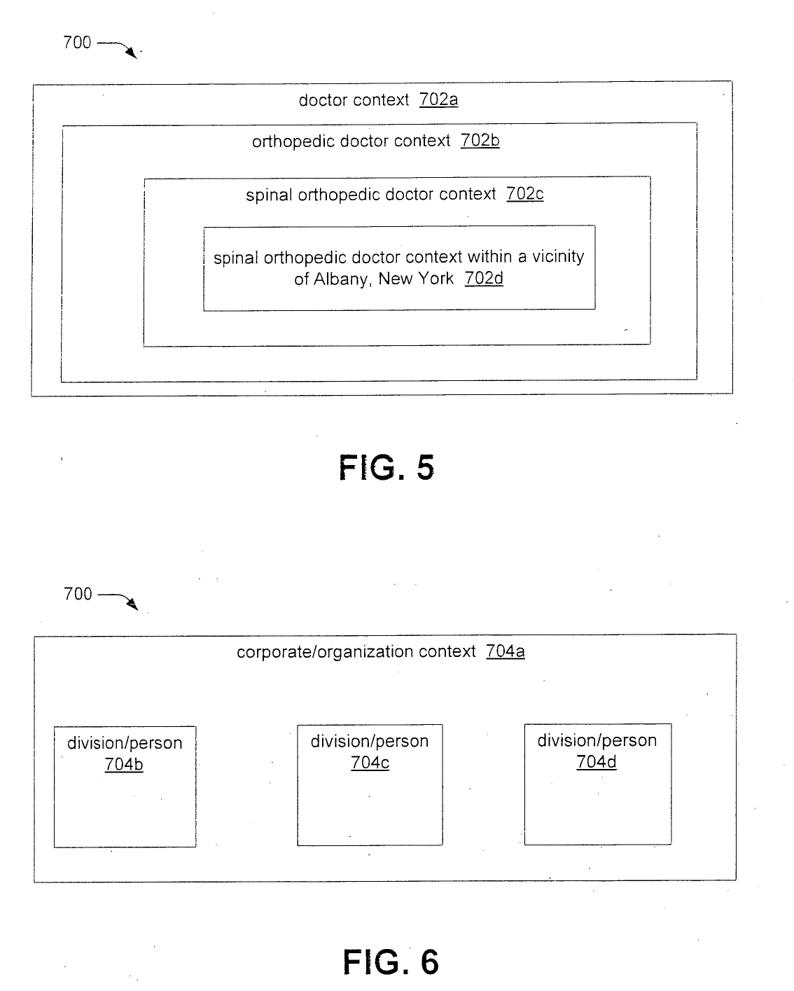

Certain embodiments of the context designated destination registry 112 can be arranged in a hierarchy to organize one or more contexts, perhaps logically. For example, FIG. 5 shows one embodiment of a context hierarchy, which can mirror a context selection process as can be performed by certain embodiments of the at least one interfacing person and/or interfacing communication device 110. In certain embodiments of the interfacing person and/or interfacing communication device 110, the context can be selected using, e.g., at least one menu(s), button(s), switches, input/output device(s), etc. The FIG. 5 embodiment of the context hierarchy includes a plurality of contexts, which by example includes a doctor context 702a, an orthopedic doctor context 702b, a spinal orthopedic doctor context 702c, and a spinal orthopedic doctor context within a vicinity of a particular geographic location 702d. As such, each subsequent context may be nested within each preceding context.

Certain embodiments of such nested contexts can be sequentially or otherwise selected using a variety of menu(s), button(s), switches, input/output device(s), etc. may be utilized during the attempt for the at least one interfacing person and/or interfacing communication device 110 to attempt to communicate with, or communicate with, the at least one identifiable person and/or identifiable communication device 108 based at least partially on the context. Each context 702a, 702b, 702c, and 702d can include zero, one or more sets of data, information, etc., certain of which may be characterized as address/context pairs. Each of the address/context pairs can be utilized, for example, to convert the address portion 312 of certain embodiments of the address-based packet 310 (of FIG. 4) to/from the context header 302 of certain embodiments of the context-based packet 300 (of FIG. 3). Certain embodiments of the context hierarchy 700, as described with respect to FIG. 5, for example, could be used by a user of certain embodiments of the interfacing person and/or interfacing communication device 110, to contact a nearby physician or other professional, and might be implemented in certain embodiments of the context designated destination communication system 100 by slight software, hardware, or firmware modification of certain embodiments of the interfacing person and/or interfacing communication device 110. The context hierarchy of the contexts 702a, 702b, 702c, and 702d as described with respect to FIG. 5 represents one particular hierarchy, such as could be included in certain embodiments of the context designated destination registry 112 as described with respect to FIGS. 1 and 2.

FIG. 6 provides another example of the context hierarchy pertaining to a number of corporate or organizational contexts 704a, 704b, 704c, 704d, 704e, and 704f, such as could be included in certain embodiments of the context designated destination registry 112 as described with respect to FIGS. 1 and 2. Each sub-context 704b, 704c, 704d, 704e, and 704f of FIG. 6, for example, is nested in the corporate, organizational, or other context 704a (which can represent, for example, the root context). Each sub-context can include such nested concepts as divisions within the corporate or organizational context 704a, individuals within the corporate or organizational context 704a, or other such context hierarchical arrangements. The arrangement or structure of such context hierarchies as illustrated in FIGS. 5 and 6 could be easily performed by those skilled in data storage devices, database technologies, as well as a variety of other memory devices. The particular configuration or arrangement of the various embodiments of the context designated destination registry 112 can be a matter of design, and those configurations as illustrated in FIGS. 5 and 6 are intended to be illustrative in nature, but not limiting in scope.

Certain embodiments of the at least one context designated destination communication mechanism 99 can even be configured to operate independently of, or in the absence of, certain embodiments of the at least one addressing communication mechanism 98. As such, certain embodiments of the context designated destination communication system 100 can even be configured to operate without, in the absence of, in combination with, and/or independently of an at least one addressing communication mechanism 98. With such configurations, the at least one context designated destination communication mechanism 99 can provide the communication and/or addressing for between the at least one interfacing person and/or interfacing communication device 110 and/or the at least one identifiable person and/or identifiable communication device 108. It is envisioned that there may therefore be considerable variation in the various embodiments of the context that can be used to establish and/or maintained communications between the at least one interfacing person and/or interfacing communication device 110 and the at least one identifiable person and/or identifiable communication device 108.

Certain embodiments of the at least one context designated destination communication system 100 can include the at least one context designated destination registry 112, as described with respect to FIG. 13, such that a variety of persons, corporations, organizations, entities, etc. Can be communicated with based at least partially based on a context. In this manner, the participating ones of the at least one identifiable person and/or identifiable communication device 108 can be communicated using a variety of the at least one context designated destination registry 112 that may act in a tabular (e.g., database or other memory) form. For instance, certain embodiments of the at least one context designated destination registry 112 can include an interfacing context such as can be used by a variety of the at least one interfacing person and/or interfacing communication device 110 in an attempt to communicate with a variety of the at least one identifiable person and/or identifiable communication device 108. Certain embodiments of the least one context designated destination registry 112 can also include an identifiable context which the interfacing context is translated to/from during certain context-based communications. As such, return communications (such as the return of duplex communications) can be translated from the identifiable context to the interfacing context.

As such, considering the instantaneous tabular embodiment of the context designated destination registry 112 as described with respect to FIG. 13 , initial communications directed to the ABC Company (CD Division) might be expected to be direct to Jane Johnson at the listed phone number, who is currently active. Such initial communications would be expected to translate from the interfacing context to the identifiable context. By comparison, return communications such as return duplex communications would be expected to be translated from the identifiable context to the interfacing context. Certain embodiments of the context designated destination registry 112 can be instantaneously modifiable by the maintainers and/or users of the registry.

In a similar manner, FIG. 13 illustrates that attempted communications for the DEF Organization could be established to Mary James and/or Jim Smith, as desired or according to some algorithm or design. Similarly, attempted communications for the vehicle licensed as CCC-2233 (for New York) could be established to the driver Art Wall, or the passenger Cathy Smith.

Certain tabular embodiments of the context designated destination registry 112, as described with respect to FIG. 13, could be provided as software, such as using a database (e.g., Structured Query Language, or SQL) such as to allow translation between the interfacing context and the identifiable context. Such software-based embodiments of databases, memories, storage devices, etc. Can be either maintained on a general purpose machine such as a personal computer, or alternately could be maintained on a specific purpose machine or device, as generally understood by those skilled in computer arts. Similarly, certain embodiments of the context designated destination registry 112 could be configured as a hardware and/or firmware embodiment, such as to have the tabular logic at least partially hard-wired.

Within this disclosure, certain embodiments of the at least one interfacing person and/or interfacing communication device 110 and/or the at least one identifiable person and/or identifiable communication device 108 can be considered as similar-type devices that are configured to communicate with each other. For example, certain embodiments of the at least one interfacing communication device 110 and/or the at least one identifiable communication device 108 could either be configured to include: conventional or modified cell phones, conventional or modified hard-line telephones, conventional or modified music and/or audio providing devices, conventional or modified videoconferencers, conventional or modified PDAs, conventional or modified mobile phones, conventional or modified audio, music, or other devices such as IPODs, conventional or modified computer-based devices, conventional or modified communication system devices, conventional or modified telecommunication system devices, data-transfer system devices, conventional or modified phone system devices, conventional or modified networked devices, or other such devices or system devices, etc., or a combination thereof. Certain embodiments of the at least one communication devices 110 and/or 108 could effectively use whichever de-facto communication modality may be convenient or necessary. For example, the at least one interfacing communication device 110 and/or the at least one identifiable communication device 108 could at least at certain times include radio ad TV.

Consider that communication (especially in emergency or important instances) may be by whatever means are necessary or functional. Consider that certain embodiments of the at least one interfacing communication device 110 and/or the at least one identifiable communication device 108 may utilize conventional means such as satellite phones., cell phones, land-lines, etc, but also may also utilize unconventional means. For instance, if the at least one interfacing person and/or interfacing communication device 110 wishes to talk to someone in a proximate vehicle, they may communicate via a non-conventional embodiment of the and the at least one identifiable person and/or identifiable communication device 108, such as the radio station channel. A number of audio or music devices such as IPODs may have WIFI, as well as cellular capability to download music. It may be possible to send people message through many embodiments of such audio/music listening devices, etc. which may be configured as certain embodiments of the context designated destination communication system 100.

Within this disclosure, certain embodiments of the communication device may include conventional devices that are configured to utilize typical cell phones, computers, PDAs, etc. (such as are commercially available) without significant modification to make them operate within certain embodiments of the context designated destination communication system 100. By comparison, certain embodiments of the communication device may include modified devices that are designed, configured, or otherwise operated particularly to make them operate within certain embodiments of the context designated destination communication system 100. Certain embodiments of the communication devices may include, for example, digital radio, television, a media that is paid for at least partially by a user, and/or a media that is at least partially paid for by an advertiser. Certain advertisements may be more effective if presented on radio or television each time the user is driving by the advertiser, such as may be considered as another example of a context. For example, certain embodiments of the context designated destination communication system 100 can provide advertisements to each vehicle subscribing to a particular media that is passing a particular store, service provider, location, etc.

As such, certain embodiments of the at least one identifiable person and/or identifiable communication device 108 and/or the interfacing person and/or interfacing communication device 110 can include conventional means such as cell phones, etc, but also unconventional means such that one user or communication device may wish to communicate with another user or communication device in a nearby vehicle that can be transmitted via phones or alternately radio station channel(s).

Certain embodiments of the at least one interfacing person and/or interfacing communication device 110 can be configured to address an at least one identifiable person and/or identifiable communication device 108 during an initial attempt to communicate therewith. Following initial contact and/or call set-up, a variety of types of communications (e.g., duplex, uniplex, or other) can be established and/or maintained between multiple ones of the at least one interfacing person and/or interfacing communication device 110 and/or the at least one identifiable person and/or identifiable communication device 108. There might be little discernible distinction between the operation and/or function of the devices within the context designated destination communication system 100 and within conventional communications, telecommunications, data-transfer, or computer-network based systems during the communication between certain embodiments of the embodiments of the at least one interfacing person and/or interfacing communication device 110 and/or the at least one identifiable person and/or identifiable communication device 108. As such, certain users of the at least one identifiable person and/or identifiable communication. device 108 and/or interfacing person and/or interfacing communication device 110 may not even be aware whether that are utilizing certain embodiments of the context designated destination communication system 100.

It may be desired that the at least one interfacing person and/or interfacing communication device 110 and/or the at least one identifiable person and/or identifiable communication device 108 may thereby be configured as conventional devices that can interoperate within one or more of certain embodiments of either the at least one addressing communication mechanism 98 and/or the at least one context designated destination communication mechanism 99. As such, for example, users of certain embodiments of phone-based context designated destination communication system 100 could utilize their conventional phones, music and/or audio providing devices, videoconference systems, etc. as certain embodiments of either the at least one interfacing person and/or interfacing communication device 110 and/or the at least one identifiable person and/or identifiable communication device 108. Certain owners or users of existing or conventional telephones, cell phones, satellite phones, videoconferencers, music and/or audio providing devices, computers, PDAs, etc. could apply their device to be used as certain embodiments of the at least one interfacing person and/or interfacing communication device 110 and/or the at least one identifiable person and/or identifiable communication device 108 in certain embodiments of the embodiments of the context designated destination communication system 100.

With certain embodiments of conventional devices used in certain context designated destination communication system 100, the at least one context identifier 102 may have to be associated as a distinct number or portion onto the at least one interfacing person and/or interfacing communication device 110 to provide context-based addressing. Similarly, certain conventional devices can be at least partially utilized as at least a portion of certain embodiments of the at least one interfacing person and/or interfacing communication device 110 and/or the at least one identifiable person and/or identifiable communication device 108. Therefore, the at least one context associator 104 may thereby be included and/or associated as a distinct member or portion onto the at least one identifiable person and/or identifiable communication device 108 to provide context-based technique to indicate and/or select the particulars of the context by which the at least one identifiable person and/or identifiable communication device 108 can communicated therewith.

Within this disclosure, the context by which certain embodiments of the at least one identifiable person and/or identifiable communication device 108 may be communicated therewith can, depending on usage, relate to such factors as the location, position, motion, state (e.g., on or off, actuated or deactuated, etc.) of the at least one identifiable person and/or identifiable communication device 108. Such locating with certain embodiments of the at least one identifiable person and/or identifiable communication device 108 can relate to locating an organization, a business, a vehicle, a medical center, a home, or in other context or association of the at least one identifiable person and/or identifiable communication device 108. For example, consider certain vehicle embodiments of the context designated destination communication system 100 that can be associated with those vehicles that can follow a highway, a waterway, an airway, etc. It may be desired for an emergency provider, department, service provider, advertiser, or other individual or group may wish to contact occupants of those vehicles and/or those persons or vehicles using at least portions or regions those particular roadways, highways, shipping lanes, waterways, airways, etc. In certain instances, it may be likely that such communications be made to any or all person within the vehicle, any or all operators or driver of the vehicle, any or all passengers of the vehicle, any person, operator, or passenger of the vehicle, the computers and/or communication devices to of the vehicle (or the vehicle itself), which is associated with the at least one identifiable person and/or identifiable communication device 108.

Certain embodiments of the context designated destination communication system 100 can be configured to communicate, or attempt to communicated with, certain embodiments of the identifiable communication device 108 based at least partially on feature of the user. Namely, certain of the at least one interfacing communication device 110 may wish to communicate with, talk to, notify, etc. other persons sharing a particular interest, being of a particular nationality, being associated with a particular company or organization, etc. Such communications or attempted communications can be within a prescribed geographic region, range, etc. Conversely, certain users of the identifiable communication device 108 can indicate that they wish to receive communications from other persons sharing a particular interest, being of a particular nationality, being associated with a particular company or organization, etc. The message can thereupon be transmitted to those people or communication devices who have suitable information or request loaded into their identifiable communication device 108 (e.g., cell phone, satellite phone, PDA, etc.) that they wish to receive such information.

Certain embodiments of the context designated destination communication system 100 can utilize at least one feature of the user. Namely, certain embodiments of the context designated destination communication system 100 can facilitate communications between certain people or particular demographics, nationalities, characteristics, belonging to certain organizations, etc. that are nearby to alert them or provide some relevant information. Conversely, a message can be provided to all those people who have actuated their context associator 104 in such a manner as to indicate that they should be alerted in the instance of communications relating to a particular context. Certain embodiments of the context can be interest-based, proximity based, emergency-based, nationality-based, demographic-based, etc.

As such, certain passengers of the vehicles can use certain embodiments of the context designated destination communication system 100 while at or traveling to certain terminals such as airports, railways stations, bus terminals, etc. Can be advised either based at least in part of their presence as the (or travel to or from) terminal or relative to an airline, train, ship, bus, etc. Alternately, certain persons considering traveling to airports, to railway terminals, on roadways, etc. Can contact certain sources for travel advisories and arrangements using certain embodiments of the context designated destination communication system 100.

By allowing certain embodiments of the at least one identifiable person and/or identifiable communication device 108 to allow other persons and/or communication devices to communicate with the based on context, certain communication devices such as phones, cell phones, PDAs, music and/or audio providing devices, car radios, etc. Can obtain an increased functionality by allowing others to communicate with them based at least partially on the context. Consider that certain embodiments of the at least one identifiable person and/or identifiable communication device 108 may desired to become associated with a particular context, even if they are not proximate or otherwise associated with the context at any given time. For example, family members who often utilize a given car may select to actuate certain embodiments of their at least one identifiable person and/or identifiable communication device 108 based on the context of a given vehicle. Therefore, in instances that the vehicle was involved with an accident, emergency, or other situations, that others would be able to contact any person such associated with the context.

As such, the suitable, participating, desired, and/or other persons associated with the at least one identifiable person and/or identifiable communication device 108 can be contacted at least partially by designating the destination based at least partially on the context (e.g., the context designated destination). As such, certain embodiments of the at least one interfacing person and/or interfacing communication device 110 can attempt to contact the certain embodiments of the at least one identifiable person and/or identifiable communication device 108 based at least partially on the context of the at least one identifiable person and/or identifiable communication device 108 (such as being associated with a particular vehicle, etc.).

Certain embodiments of the at least one identifiable person and/or identifiable communication device 108 can be communicated with using certain embodiments of the context designated destination communication system 100 based on such contexts as home addresses, building locations, businesses, organizations, entertainment centers, medical centers, organizations, etc. With certain conventional business, medical, organizational, or other groups of people, certain people may be away from and/or not reachable by at least certain ones of their communication devices such as phones, computers, music and/or audio providing devices, videoconference systems, etc. for certain periods. There may be a number of times when certain persons may, wish to be reached by at least one from a variety of their communication devices. For example, a medical doctor mail be on their rounds, etc. It may be desired that they can be reached on their cellular phone, PDA, or satellite phone, etc. when being contacted on their office phone, business computer, etc. Alternately, a corporate executive, business employer or employee, or other worker may be traveling away from their office and/or office phone, and it may be desirable to communicate with the executive via their cell phone or e-mail on a remote personal computer, music and/or audio providing device, or personal display assistant (PDA) based at least in part on context. As such, at least for certain periods, durations, days, etc., there may be a variety of users of the identifiable person and/or identifiable communication device 108 and/or interfacing person and/or interfacing communication device 110 who another user may desire to contact or communicate with, such as a doctor or ambulance operator for an advisory or emergency, business situation, or other such- event based at least partially on context. In certain instances, the particular type of device (e.g., phone, email, music and/or audio providing device, radio, etc.) being used for the contact or communication may be irrelevant.

As such, this disclosure provides a variety of embodiments of the context designated destination communication system 100 in which a number of the at least one interfacing person and/or interfacing communication device 110 and/or the at least one identifiable person and/or identifiable communication device 108 can communicate with each other based at least in part on a locational context, a proximity context, a medical context, a business-method context, a vehicle context, and/or another such context of the at least one identifiable person and/or identifiable communication device 108.

Certain embodiments of the at least one context associator 104 can be configured, depending upon usage, either manually and/or automatically to associate the at least one identifiable person and/or identifiable communication device 108 with a particular context. Certain aspects of context as can be derived by certain embodiments of the at least one context associator 104, as can be included within the at least one identifiable person and/or identifiable communication device 108, can thereupon be relied upon by the at least one context designated destination communication mechanism 99 and/or the at least one addressing communication mechanism 98. Certain aspects of the context can thus be derived by certain embodiments of the at least one context associator 104. Certain aspects of the context can thereby be used, by certain embodiments of the at least one identifiable person and/or identifiable communication device 108 and/or at least one interfacing person and/or interfacing communication device 110, to attempt, establish, and/or maintain at least one communication within the context designated destination communication system 100. Certain embodiments of the context can be associated with the at least one identifiable person and/or identifiable communication device 108 at least partially manually. A variety of input devices can be utilized to allow the identifiable person to interface to input the context at least partially utilizing the at least one context associator 104. Such input devices can take the form of, for example, but are not limited to: a menu, a keypad, a dialing mechanism, a wired-based and/or wireless actuation mechanism, etc.

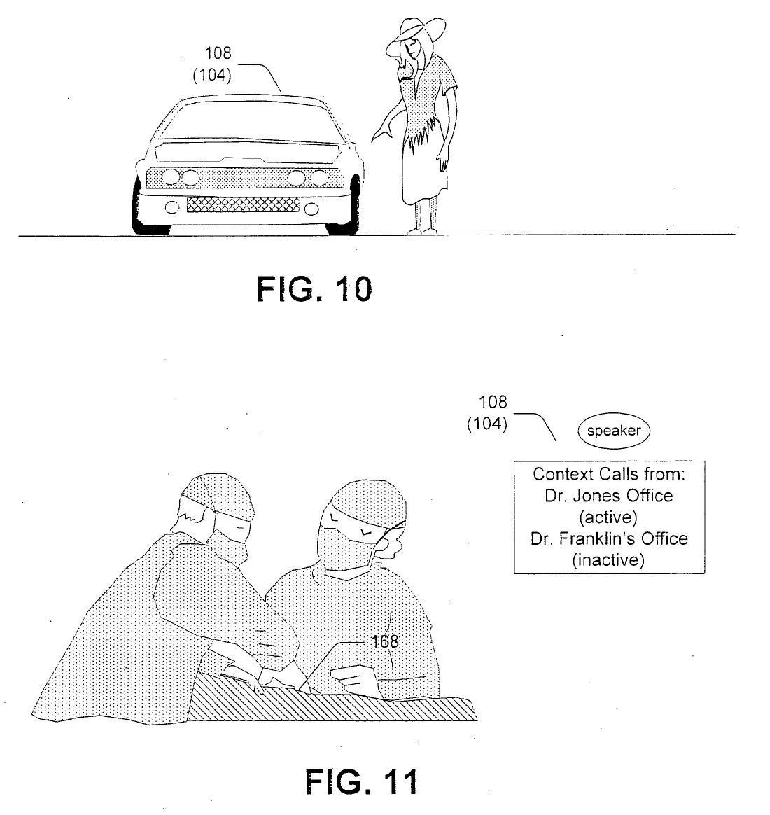

Certain embodiments of the context, as selected by the at least one context associator 104, can be automatically associated with the at least one identifiable person and/or identifiable communication device 108. Certain of such at least one automated context, and/or associations by the at least one context associator 104, can be applied based on a sensed presence or recognition of the identifiable person being proximate or associated with the at least one identifiable person and/or identifiable communication device 108, as described with respect to FIG. 10. Such sensed presence or recognition can rely upon, for example: proximity sensors, image recognition, image processing, data processing, and other generally known techniques. Automation of the at least one context associator 104 can utilize, for example, an at least partially automated computer, controller, system, mechanism involving hardware, software, firmware, an at least one electromechanical device, an at least one mechanical devices, etc., or any combination thereof that can be at least partially controlled by any of or any combination of the at least one identifiable person and/or identifiable communication device 108, the at least one context designated destination communication mechanism 99, and/or the at least one context associator 104.

As such, certain embodiments of the at least one context associator 104 can at least partially automatically and/or manually establish a context that can be used to at least partially establish, and/or control communications between the at least one interfacing person and/or interfacing communication device 110 and the at least one identifiable person and/or identifiable communication device 108.

Certain embodiments of the context designated destination communication system 100 can base or determine the establishing, and/or controlling communications at least partially on privacy considerations. For example, certain users of certain embodiments of the at least one identifiable person and/or identifiable communication device 108 can select by which of the at least one context(s) can be used to contact or communicate with them, when they can be contacted. For example, a person can select a particular duration, location, etc. (such as during working hours, when at a worksite, when selected by a user, when traveling in a vehicle, etc.) by which they can be contacted over one or more of their at least one (e.g., work-related) identifiable person and/or identifiable communication device 108 such as phone systems, audio or music devices, videoconference systems, radio systems, etc. In certain instances an employer and/or employee can select how to establish such context-based associations either automatically or manually, such as when certain workers approach their job location (such as being within a range of the recognizer, etc.), are actuated in some manner by the workers such as the at least one identifiable person and/or identifiable communication device 108 being turned on, and/or some other mechanism such as starting working.

Additionally, certain users such as employers and/or employees could be contacted over certain work-related embodiments of the at least one identifiable person and/or identifiable communication device 108 even when they are not physically situated at work. For example, certain employers and/or employees could be contacted for work-related activities on a context-associated car phone, context-associated music and/or audio providing device, context-associated cell phone, context-associated satellite context-associated phone, context-associated videoconference, context-associated, or other context-associated device when they are traveling to or from work. Alternately, certain employees and/or employers can configure their home telephone to provide communications that may be directed to them and their work number, etc. such that can be used to allow the employee and/or employer to more effectively work at home. As such, it becomes possible for each person to be associated with phones, communication devices, videoconference systems, etc. that can communicate and/or attempt communications based at least partially on one or more distinct contexts (being in a location, being at a particular work location, being within a particular vehicle, being in a particular building, etc.).

While certain contexts being utilized by certain embodiments of the context designated destination communication system 100 are location or geographic based, certain embodiments of the context can rely at least partially on a current topic or location of the professional. For example, a working professional whose location, time, other persons, etc. could indicate the discussion about a professional topic, when the user prompts to contact a professional associate (e.g., by name). Certain embodiments of the context designated destination communication system 100 can be configured to communicate with the professional associate at least partially based on the context of the present communication. In certain instances, the user can thereby be communicating in a manner that indicates at least one context-providing data source. For example, a person might be on a phone in an ambulance, and if the person attempts to make a communication, chances are increased that the context of the communication is medical in nature. If a business executive is making a context-type statement in an office, for example, chances are increased the context of communication is professional in nature as compared to if the communication is being made from their home. By comparison, if the doctor or business professional is making a comment on a ski slopes are on a fishing trip, chances are that increased that the context of the communication is not professional in nature. As such, certain embodiments of the context designated destination communication system 100 can take into consideration where, to whom, from whom, the location of the communication, the nature of the communication, and other such factors in selecting the most likely context of the communication. Such techniques as weight factors, artificial intelligence, scheduling, detectors, etc. Could be utilize to determine probabilities of a particular contexts, for example.

There are a variety of business persons, professionals, assistants, organizational persons, officers, military persons, etc. Third home for whom context can be determined based at least partially on their status. Examples of such medical professionals, for example, could include, but are not limited to, for example: doctors, medical assistants, ambulance drivers or attendants, paramedics, etc. As such, certain embodiments of context associating and context identifying goes considerably beyond a three-dimensional definition in space. For instance, certain embodiments of the context designated destination communication system 100 can be configured or operated to have knowledge about what a particular person is presently doing, what they have finished doing, how busy they may be, whether it is business hours vs. not business hours. In the instance of a sick to a sick or injured patient being transported, for example, certain embodiments of the context designated destination communication system 100 can be configured such that an ambulance driver, orderly, doctor, medical assistant, etc. to determine a desirable location (or even optimal location, facility, operating room, etc.) for the patient should be transported and/or located.

Certain embodiments of the context designated destination communication system 100 can utilize context based on a combination of a number of features. Consider an instance when a person is traveling in a vehicle, physical structure, dwelling, building, etc., and suddenly experiences a condition such as, but not limited to call a chest pain. Certain embodiments of the interfacing person and/or interfacing communication device 110 and/or the identifiable person and/or identifiable communication device 108 can provide at least one context-based options, such as calling a MD that is currently available that may subscribe to the patient's insurance options (e.g., non-spatial reference), and/or providing directions for the patient (or other person) to a nearby hospital, doctor's office, emergency room, or other suitable location (e.g., spatial reference).

Consider that as such when the patient's chest pain is really getting bad, and the patient believes they are going to pass out. Certain embodiments of the context designated destination communication system 100 may be configured to alert suitable medical professionals, and/or alerting other vehicles around the person in trouble (e.g., providing unimodal or multimodal communication based on the patient's context). As such, certain embodiments of the context designated destination communication system 100 can be configured to alert proximal vehicles and/or nearby ambulances, etc. of the patient's condition by cell phone, radio, SMS, etc.

Certain of the at least one identifiable person and/or identifiable communication device 108 and/or the at least one interfacing person and/or interfacing communication device 110 can be configured as a personal device, a business device, an organizational delays, and/or another device which, except for their use in the context designated destination communication system 100, would be considered as conventional communication, telecommunication, data-transfer, or networked devices. However, certain users of certain embodiments of the context designated destination communication system 100 can be contacted at certain times on one or more of the at least one identifiable person and/or identifiable communication device 108 and/or the at least one interfacing person and/or interfacing communication device 110.

Regardless whether the initial or primary purpose of certain embodiments of the at least one identifiable person and/or identifiable communication device 108 and/or the at least one interfacing person and/or interfacing communication device 110 is business-related, pleasure-related, and/or personal-related, each of such communication device 108 and/or 110 can be configured to be used for a variety of such purposes depending at least in part on an associated context of the identifiable person and/or identifiable communication device 108. For example, certain embodiment of the identifiable person and/or identifiable communication device 108 that have been purchased for personal use may be configured, based on context association as provided by certain embodiments of the context associator 104, to operate as a work phone, a travel advisory phone, and emergency contact phone, music and/or audio providing device, etc.

Certain embodiments of the at least one interfacing person and/or interfacing communication device 110 and/or identifiable person and/or identifiable communication device 108 can utilize a variety of configurations of conventional cell phone, satellite phone, videoconference, a music and/or audio providing device, or land-line technologies. Consider that certain conventional phone users who desire a particular type or quality of service may thereby be forced to purchase, use, or otherwise obtain multiple conventional cell phones, satellite phone, music and/or audio providing devices, videoconferencers, and/or land-lines, etc. for a variety of purposes. Since each communication device is often relatively complex to operate and/or may utilize a variety of graphical user interfaces (GUIs), menus, buttons, input/output devices, etc.; each user may find the multiple devices confusing are difficult to operate, understand, or master. For example, certain users may have access to a cell phone, a land-line phone, a computer, a PDA, a satellite phone, and/or a videoconference for home or entertainment purposes, as well as a cell phone, a computer, a PDA, a music and/or audio providing device, a land-line phone, a satellite phone, and/or videoconference for business purposes. Recently, certain business persons, doctors, researchers, employees, self-employee, contractors, or other people ma)y therefore have multiple, and some have an excessive number of, communication devices such as phones (of different types), audio or music devices, computers, PDAs, etc. Such numerous communication devices are typically expensive to purchase, maintain, build, design, and/or dispose of.

It is likely that such conventional-phone users, music and/or audio providing device users, or users of other devices may leave one or more of their personal communication devices, phones, computers, videoconference systems, music and/or audio providing devices, etc. when they go to work; or alternately may leave some of their work-based devices, phones, computers, videoconference systems, etc. at work when they go home or travel on pleasure. As such, each user may have a number of devices which they or their employer may pay for and/or ma)y utilize each communication device on a potential full-time use, but which they typically only use for a portion of a day.

Certain conventional devices may be viewed as being devoted to a particular context (located at work, in a vehicle, in a home, etc.). Big comparison, certain embodiments of the identifiable person and/or identifiable communication device 108 and/or interfacing person and/or interfacing communication device 110 can, as described in this disclosure, be used for a variety of contexts depending on such factors as an instantaneous location of the user, building in which the user is situated, company or organization whose communications to which the user wishes to respond, or vehicle of the user.

There can be a variety of pricing and/or charging techniques associated with different ones of the interfacing person and/or interfacing communication device 110 and/or the identifiable person and/or identifiable communication device 108 within the context designated destination communication system 100. Certain embodiments of the context designated destination communication system 100 can include a charge-transferring mechanism to charge context-based work-related phone calls to work, and home-related context-based phone calls to home. As such, even though a particular phone, music and/or audio providing device, PDA, computer, etc. may be work-related or home directed, when it is being applied to some context that differs from the primary purpose, certain embodiments of the at least one interfacing person and/or interfacing communication device 110 and/or at least one identifiable person and/or identifiable communication device 108 can be charged based at least partially on the context. Certain embodiments of the at least one interfacing person and/or interfacing communication device 110 and/or at least one identifiable person and/or identifiable communication device 108 can include a menu, a graphical user interface (GUI), or some other input/output device that can allow selection of the context towards which a particular communication is directed toward and/or from as well as a suitable pricing/charging technique.

Certain embodiments of communication devices such as the at least one interfacing person and/or interfacing communication device 110 and/or the at least one identifiable person and/or identifiable communication device 108 may be desired to be used for only a portion of a day, only with certain privacy considerations, or for only certain roles, etc. Such limited use of certain embodiments of the identifiable person and/or identifiable communication device 108 and/or the at least one interfacing person and/or interfacing communication device 110 can therefore lead to their diminished usage for at least certain communication devices, phones, music and/or audio providing device, computers, PDAs, videoconference systems, etc. Consider that for each user to have multiple useful personal-related communication devices and multiple useful professional-related communication devices (each communication device may include, e.g., a hard-wired phone, a VOIP device, a cell phone, a computer, a satellite phone, a music and/or audio providing device, a PDA, etc.) that could be accessed at any given time, durational of such devices would have to be with the person. As such, each user may have to carry the personal-related communication devices with them for any time period that they wish to respond personally for each particular communication device. There may be a variety mechanisms by which the person or user of the identifiable person and/or identifiable communication device 108, or other device, can select which device shape for other embodiments of the at least one interfacing person and/or interfacing communication device 110, and use for the to contact them with.

Certain embodiments of the at least one context associator 104 can therefore be configured to allow at least one identifiable person and/or identifiable communication device 108 and/or at least one interfacing person and/or interfacing communication device 110 to attempt to communicate and/or communicate with (perhaps similar to proxy-like) based at least partially on the context such as can be selected by the user either at certain embodiments of the context identifier 102 or at certain embodiments of the at least one context associator 104.

As generally understood by those skilled in networking, data-transfer, and/or telecommunication switching applications, certain embodiments of the at least one context designated destination communication mechanism 99 can thereby be configured to control operation of at least a portion of the context designated destination communication system 100 and/or be structured to extend across certain ones of the at least one interfacing person and/or interfacing communication device 110 and/or the at least one identifiable person and/or identifiable communication device 108. For example, certain embodiments of the at least one context designated destination communication mechanism 99 can be configured to include, but may not be limited to, certain embodiments of at least one context identifier 102 that can be included in the at least one interfacing person and/or interfacing communication device 110. Similarly, certain embodiments of the at least one context designated destination communication mechanism 99 can be configured to include, but not be limited to, certain embodiments of the at least one context associator 104 that can be included in the at least one identifiable person and/or identifiable communication device 108.

Certain embodiments of the context designated destination communication system 100 can also include, but are not limited to, at least one addressing communication mechanism 98 that can provide for alternate (or supplemental) communications between the at least one interfacing person and/or interfacing communication device 110 and/or the at least one identifiable person and/or identifiable communication device 108 can be used to attempt to communicate and/or provide communication based at least partially on an addressing scheme. For example, a communication systems including, but not limited to, a plain old telephone system (POTS), a telecommunication system, a data-transfer system, a VOIP system, a communication system, a network, etc. that is conventionally configured can represent certain embodiments of the addressing communication mechanism 98. The configuration of the addressing communication mechanism 98 can, depending on context, be configured, for example, on the configuration and/or operation of the at least one interfacing person and/or interfacing communication device 110 and/or the at least one identifiable person and/or identifiable communication device 108. Certain embodiments of the at least one interfacing person and/or interfacing communication device 110 can, depending upon usage, be configured during normal operation as to be similar to, and/or be interchangeable with, certain embodiments of the at least one identifiable person and/or identifiable communication device 108.

Certain of the devices 110 and/or 108 can be identically configured, and may vary function and/or operation depending upon whether the user is attempting to establish, or establishing, or attempting to receive, or receiving a communication. For instance, a particular device can be configured as the identifiable person and/or identifiable communication device 108 and one communication, and as the interfacing person and/or interfacing communication device 110 in another communication. As such, similar data, information, etc. can be transferred between the at least one interfacing person and/or interfacing communication device 110 and the at least one identifiable person and/or identifiable communication device 108, to allow communication therebetween.

Certain embodiments of the addressing communication mechanism 98 can be configured to provide conventional communication methodologies between multiple of the at least one identifiable person and/or identifiable communication device 108 and/or interfacing person and/or interfacing communication device 110. Certain embodiments of the addressing communication mechanism 98 can be configured as a variety of devices including, but not limited to: plain old telephone systems, or analog-based or digital-based switched communication systems, telecommunication systems, a data-transfer system, a VOIP system, and/or computer systems in those instances which the at least one interfacing person and/or interfacing communication device 110 and/or the at least one identifiable person and/or identifiable communication device 108 can be configured as, for example: telephones (either analog and/or digital, as well a sale, satellite, land-based, or other), fax machines, data communication devices, information communication devices, videoconference systems, computers, facsimile machines, etc., and/or a combination thereof. Certain embodiments of the context designated destination communication system 100 can be configured to allow alternate communications between the at least one interfacing person and/or interfacing communication device 110 and the at least one identifiable person and/or identifiable communication device 108 either via the context designated destination communication mechanism 99 and/or the addressing communication mechanism 98. Certain embodiments of the context designated destination communication system 100 may allow for the users of the at least one interfacing person and/or interfacing communication device 110 and/or the at least one identifiable person and/or identifiable communication device 108 to be unaware which, both, if any, of the addressing communication mechanism 98 and/or the context designated destination communication mechanism 99 is attempting to provide or provide communications.

In instances or periods where no, limited, diminished, or otherwise altered, context-based communications may be permitted via the context designated destination communication mechanism 99, it may be desired that addressing and/or communications can be provided via the addressing communication mechanism 98. Similarly, in instances where no communications and/or addressing may be permitted via the addressing communication mechanism 98, it may be desired that communications and/or attempted communications can be provided via the context designated destination communication mechanism 99. As such, certain embodiments of the context designated destination communication mechanism 99 and the addressing communication mechanism 98 may be considered as an alternate network or a communication provider between the at least one interfacing person and/or interfacing communication device 110 and the at least one identifiable person and/or identifiable communication device 108.

In general, certain embodiments of the context designated destination communication mechanism 99 can, at least partially or fully, integrate and/or extend across an at least one context identifier 102 and/or an at least one context associator 104. Certain embodiments of the context designated destination communication mechanism 99 can thereby control and/or providing communications between certain ones of the at least one interfacing person and/or interfacing communication device 110 and/or the at least one identifiable person and/or identifiable communication device 108. Certain embodiments of the context designated destination communication mechanism 99 can be situated functionally, structurally, or operationally (based on hardware, software, and/or firmware) aspects as described in this disclosure within at least one of the at least one context identifier 102, the at least one identifiable person and/or identifiable communication device 108, the at least one interfacing person and/or interfacing communication device 110. In certain instances, a network or communication portion may operationally connect such devices, and/or a combination of the devices.

Certain embodiments of the context designated destination communication mechanism 99 can be configured to translate the attempted interface that is at least partially generated by the at least one interfacing person and/or interfacing communication device 110 to the at least one identifiable person and/or identifiable communication device 108 located at a particular location, into an actual or attempted communication with the at least one identifiable person and/or identifiable communication device 108. Certain embodiments of the translation, mapping, etc. can depend at least in part on specifying at least one context designated destination that at least partially associates an at least one identifiable person and/or identifiable communication device with an at least one context.

Certain embodiments of the respective at least one interfacing person and/or interfacing communication device 110, as well as certain embodiments of the at least one identifiable person and/or identifiable communication device 108, can therefore be associated with the respective “interfacing person” and the “identifiable person”. Such association between the at least one identifiable person and the at least one associated identifiable communication device 108, and/or the at least one interfacing person and/or the at least one interfacing communication device 110 is this disclosure can be related to the actual use of the respective communication devices by the associated persons, as well as the information between the persons.

This disclosure thereby describes a variety of communications (e.g., phone call, computer communication, data-transfer, information transfer, etc.) that can be established and/or maintained at least partially between certain embodiments of the at least one identifiable person and/or identifiable communication device 108 and/or the at least one interfacing person and/or interfacing communication device 110. In actuality, it is likely the respective identifiable person and/or the interfacing person that may be considered as respectively communicating or receiving the communication utilizing the communication to the at least one identifiable person and/or identifiable communication device 108 and/or the at least one interfacing person and/or interfacing communication device 110. Similarly, certain communication (e.g., phone call) can be established and/or maintained between certain embodiments of the at least one interfacing person and/or interfacing communication device 110 and/or the at least one identifiable person and/or identifiable communication device 108, such as may literally be applied from the interfacing communication device. An interfacing person may be considered as establishing and/or maintaining the communication between the at least one interfacing person and/or interfacing communication device 108 and the at least one interfacing person and/or interfacing communication device 110.

Certain embodiments of the at least one interfacing person and/or interfacing communication device 110 can attempt to establish, or establish, communications with certain embodiments of the at least one identifiable person and/or identifiable communication device 108 based at least in part on an at least one context designated destination. Certain embodiments of the at least one context designated destination can be based, at least in part, on a context of the at least one identifiable person and/or identifiable communication device 108. Examples of certain contexts of the at least one identifiable person and/or identifiable communication device 108 can include, but are not limited to, location within or association with a vehicle or roadway or trail, or location within or association with a building, home, room, space, geographic location, etc. For instance, attempting to communicate with each of the at least one identifiable person and/or identifiable communication device 108 in vehicles along a section of roadway or highway, such as can be used to provide warnings, advisories, directions, and/or advertisements, etc.

Certain embodiments of the at least one context designated destination can be viewed as a context based at least partially on the context of the at least one identifiable person and/or identifiable communication device 108. A user of certain embodiments of the at least one interfacing person and/or interfacing communication device 110 may wish to communicate with certain embodiments of the at least one identifiable person and/or identifiable communication device 108 based on a location, function, or operation of the at least one identifiable person and/or identifiable communication device 108. This compares to conventional device addressing schemes such as communicating and/or attempting to communicate via the communication device such as a phone (e.g., phone-type addressing relying on switching or other technology).

There may be a variety of embodiments of the at least one identifiable person and/or identifiable communication device 108 and/or the at least one interfacing person and/or interfacing communication device 110 for which communication can be established therebetween based at least in part on the utilization of the at least one context. designated destination. For instance, certain communication (e.g., phone) systems could use information about the at least one context of phones, videoconference systems, etc. to address them.

The context of certain embodiments of the context designated destination communication system 100 could be inferred by the infrastructure, entered by the user, acquired by the phone, and/or music and/or audio providing devices, (or possibility other device e.g. from signals or other information at its location), and/or by other technique based at least in part on the at least one context designated destination. Certain embodiments of the context designated destination could take the form of a class of locations with certain attributes or a label for a particular location and/or one or more phones, videoconference systems, etc. with specific attributes associated with the context such as being situated within a particular context-based location. For instance, certain phone-based, e-mail-based, audio-based, or other communication device based embodiments of the context designated destination communication system 100 can determine, based at least partially on user input or alternately a sensed state or condition, that a particular user might be determined based upon the particular condition or state. Certain embodiments of the context designated destination communication system 100, or alternately a user certain embodiments of the context designated destination communication system 100, may provide information that it particular user is wearing particular clothing, appearing in a particular manner, is at a particular location, etc.

A user of a particular identifiable person and/or identifiable communication device 108 may be identified by such identifiable information as, for example, an individual associated with certain embodiments of at least one identifiable person and/or identifiable communication device 108 might have some identifiable physical characteristic, such as are wearing identifiable dark clothing. As such, users of certain embodiments of the interfacing person and/or interfacing communication device 110 may attempt to contact the identifiable person and/or identifiable communication device 108 based at least in part on the context associated with a certain at least partially identifiable appearance (e.g., the user is a man wearing dark clothing). In those instances, where the identifiable characteristic matches between the attempted communication and the user input to the identifiable person and/or identifiable communication device 108, the call may be established. By comparison, in those instances where the identifiable characteristic does not match the attempted communication and the user input to the identifiable person and/or identifiable communication device 108, the call may be blocked. As such, an attempted communication to an identifiable person (such as with particular clothing or appearance) can be attempted, such as to “call the guys in the black sweater”. The description of the black clothing as the identifiable characteristic is illustrative nature, and is not intended to be limiting in scope. Other examples of identifiable characteristic can include, but are not limited to height of the person, weight of the person, clothing type of style of the person, business department, organization, area of habitation of the person, current area of location of the person, etc.

Input to the calling process in certain embodiments of the context designated destination communication system 100 could be photographic, textual, descriptive, verbal, etc. For instance, with photographic input, someone could capture or otherwise obtain an image, a photo, or other related information at least partially pertaining to the identifiable person and/or identifiable communication device 108. Certain embodiments of the context designated destination communication system 100 can interface based at least partially upon image recognition techniques. Certain embodiments of the context designated destination communication system 100 can allow the interfacing person and/or interfacing communication device 110 to contact the identifiable person and/or identifiable communication device 108.

Certain embodiments of the context designated destination communication system 100 can be configured to reject, transfer, or otherwise handle an attempted communication or communication (e.g., a particular location) considering organizational, privacy, safety, or other aspects. In considering certain privacy, aspects, consider that the entering of certain individuals into the identifiable context of the context designated destination registry 112, as described with respect to FIG. 13, can involve privacy aspects as well as safety aspects both for the at least one identifiable person and/or identifiable communication device 108 as well as the at least one interfacing person and/or interfacing communication device 110. For example, if an attempted communication comes to the at least one identifiable person and/or identifiable communication device 108 that is currently unavailable, such as by sleeping or driving a vehicle, then certain embodiments of the context designated destination communication system 100 may, “reject” such an attempted communication. In certain instances, after a first attempted communication based on context fails, then it may be possible for certain embodiments of the context designated destination communication mechanism 99 to redirect the communication to, for example, another phone, audio device, or other such device in the vehicle, business, house, region, location, etc. that might also satisfy the context. As such, certain embodiments of the context designated destination communication system 100 can, in addition to “rejecting” a communication, have an option to “transfer the attempted communication locally” in a manner that satisfies the context. Certain embodiments of the context designated destination communication mechanism 99 may include a list of the other phones, VOIP devices, videoconference systems, music and/or audio providing devices, etc. in the location (e.g., device or user) such as may be specified by the caller. Certain ones of such other devices, systems, or terminals may thereupon be provided to the interfacing person and/or interfacing communication device 110, and based upon the response, certain embodiments of the context designated destination communication system 100 could allow at least a portion of the context designated destination communication system to reattempt the communication with at least one identifiable person and/or identifiable communication device 108. Such contact or attempted contact may be attempted and/or performed either automatically and/or manually.

Certain embodiments of the at least one interfacing person and/or interfacing communication device 110, as well as certain embodiments of the at least one identifiable person and/or identifiable communication device 108, may each therefore be associated with a particular person. Therefore, a variety of embodiments of communication devices may be intended to be included as at least a portion of the at least one interfacing person and/or interfacing communication device 110 as well as the at least one identifiable person and/or identifiable communication device 108. Examples of the computerized communications devices that are intended to be associated with a person can include, but are not limited to: certain cellular-phones, certain music and/or audio providing devices, certain satellite phone, videoconference systems, certain personal computers (PCs) or other computers, certain personal display assistants, certain radio devices, certain satellite radio devices, etc.

Alternately, certain embodiments of the at least one interfacing person and/or interfacing communication device 110 as well as the at least one identifiable person and/or identifiable communication device 108 can be configured to be largely or entirely automated. As such, having an associated person with any particular communication device may not be necessary for certain embodiments of the at least one interfacing person and/or interfacing communication device 110 as well as the at least one identifiable person and/or identifiable communication device 108. For example, certain computer devices and/or systems such as can generate emails, recorded phone calls, etc., as with certain phone devices, automated calling systems, automated music and/or audio providing devices, etc. Certain embodiments of the interfacing person and/or interfacing communication device 110 and/or the identifiable person and/or identifiable communication device 108 can operate largely or entirely automatically or based on computer operation.

As such, certain automated embodiments of the at least one interfacing person and/or interfacing communication device 110 as well as certain automated embodiments of the at least one identifiable person and/or identifiable communication device 108 may therefore not be associated with a particular person. Examples of the communication devices that are not intended to be associated with a person therefore can include, but are not limited to, for example: certain computer servers, certain data servers, certain automated phone devices, certain answering services, certain computer device, certain music and/or audio providing devices, certain phone devices, certain terminals, etc.

For instance, when the identifiable person and/or identifiable communication device 108 obtains becomes associated with a context (e.g., gets in a vehicle, reaches a location, indicates that a may wish to become associated with the context as can be preformed by certain embodiments of the context associator 104 etc.), then certain embodiments of the at least one identifiable person and/or identifiable communication device 108 can obtain context information (such as a context-based signal). The context-based information can identify at least one context (e.g., including attributes such as for a vehicle, the license plate information, the vehicle identification number, the vehicle's make and model, etc.) associated with the at least one identifiable person and/or identifiable communication device 108 and/or interfacing person and/or interfacing communication device 110. The context-based information can be considered as one form of context. Certain embodiments of the context-based information can be made available to, transferred over, stored, modulated, processed within a device, or otherwise utilized by a network including the at least one interfacing person and/or interfacing communication device 110 and/or the at least one identifiable person and/or identifiable communication device 108.

Certain of the at least one interfacing person and/or interfacing communication device 110 can be configured to communicate with someone in a particular vehicle (e.g., with the prescribed license plate number, etc.). Such attempted contact to a person in a vehicle may thereby provide for contacting the at least one identifiable person and/or identifiable communication device 108 in a maimer as may establish and/or maintain a communication with a the at least one identifiable person and/or identifiable communication device 108 of one or more of the driver or passengers. Certain embodiments of the at least one context identifier 102 could obtain the vehicle identifier (e.g., license plate information, make, model, color, etc.) from image recognition of an image of some context identifier so the vehicle could be reasonably well identified such as by capturing or otherwise processing an image, photo, etc. of the vehicle. Examples of such vehicle identifiers include, but are not limited to, license plates, ships names, vehicle identification number, aircraft registration numbers, make, model, or type of vehicle and/or other distinct vehicular characteristic identifiers. Similarly, other examples of identifiers, such as can be used to associate certain embodiments of the identifiable person and/or identifiable communication device 108 with a particular context, can include but is not limited to: addresses, streets, family location, business name, business-type, organization, operation, etc. Thereupon, certain communicating and/or attempting communicating using certain embodiments of the context designated destination communication system 100 can be established in such manner such as by, e.g., contacting the vehicle, or persons therein, that can be reasonably are accurately identified such as by license plate number, registration number, type, color, make, model, or other identifier of the vehicle.

Certain embodiments of the context designated destination communication system 100 can, depending on use and/or configuration allow the at least one interfacing person and/or interfacing communication device 110 to interface and/or communicate with other at least one identifiable person and/or identifiable communication device 108, utilizing at least one context identifier 102. Certain embodiments of the context identifier 102 can be configured as a memory module, database, or other such devices capable of storing data, information, etc. that can operate based, at least partially, on a context-set based designated destination system. Certain embodiments of such context-set based designated destination systems may be associated with either the at least one identifiable person and/or identifiable communication device 108 and/or the at least one interfacing person and/or interfacing communication device 110. The at least one context of certain embodiments of the context-associating module can be set based, at least in part, using each, other ones, or some combination of multiple ones of the respective context-associating modules.

Certain embodiments of the context designated destination communication system 100 can thereby be configured to allow for interfacing, addressing, setting-up, or communication, between one or more persons and/or communication device 110 and/or at least one identifiable person and/or identifiable communication device 108, based at least in part on at least one context. For example, it may be desirable to communicate with those people, devices, and/or machines (e.g., computer-based) that are associated with a particular location, vehicle, business, building, home, organization, activity, etc. Certain ones of the at least one interfacing person and/or interfacing communication device 110 may be used to contact those at least one identifiable person and/or identifiable communication device 108 within vehicles traveling on or in certain related roadway, waterway, railroad, airway, or other locations, regions, etc.

Certain ones of the at least one interfacing person and/or interfacing communication device 110 may be used to contact those at least one identifiable person and/or identifiable communication device associated with a particular building, region, or vicinity; a particular business, company, activity, organization, or industry, etc. As such, multiple persons and/or communication device 110 (e.g., such as one or more of: computers, controllers, hardware, software, firmware, devices, etc.) and/or their at least one interfacing person and/or interfacing communication device 110 can thereby interface with other at least one identifiable person and/or identifiable communication device 108 or 110.

Certain embodiments of the context designated destination communication system 100 can be configured to allow communication between one or more persons and/or communication device 108 or 110 whose current addressing scheme may not be context-based (e.g., traditional phone devices, music and/or audio providing devices, cell phone devices, satellite phone, videoconference devices, computer devices, email devices, etc.), such as mall utilize certain embodiments of the addressing communication mechanism 98. By comparison, certain embodiments of the context designated destination communication system 100 can be configured to allow communication between at least one person and/or communication device 108 or 110 whose current addressing scheme is context-based at least partially by certain embodiments of the context designated destination communication mechanism 99. Certain embodiments of the context designated destination communication mechanism 99 can be configured to utilize a translator, etc. such as can be used to provide translation from a relatively ambiguous specification as associated with the at least one context designated destination to a relatively precise specification such as the device address of the at least one identifiable person and/or identifiable communication device 110.

Within this disclosure, certain embodiments of the at least one interfacing person and/or interfacing communication device 110 and/or the at least one identifiable person and/or identifiable communication device 108 can be generalized as the person and/or communication device 108 or 110. Certain embodiments of the person and/or communication device as referenced by the reference characters 108 and/or 110 can be configured to perform either the interfacing, identifiable, addressed, transmitting, and/or receiving roles at different times and/or concurrently. As such, it might be desirable for certain persons and/or communication devices (108 or 110) to interface utilizing such embodiments of the context designated destination communication system 100 based on where other at least one person and/or communication device (108 or 110) are located. For instance, it might be useful to allow multiple person(s) and/or communication device(s) 108 or 110 to interface with other ones of the at least one identifiable person and/or identifiable communication device based upon such context as the other persons being are context-associated with a vehicle, building, house, office, classroom, theater, store, etc. As such, certain embodiments of the at least one context can be based on such factors as, for example, location, activities, organization, employer, etc. of the person or communication device being called.

Certain embodiments of the particular context-set for at least one interfacing person and/or interfacing communication device 110 and/or at least one identifiable person and/or identifiable communication device 108 can vary depending on type and/or configuration of the persons and/or communication device 108 or 110 included within or associated with the context designated destination communication system 100. Certain embodiments of the context-set can include, but may not be not limited to depending on the application, such factors or parameters as: location or type of operation being performed by each communication device 110 and/or 110; status of vehicle, room, office, or other identifiable location of the at least one communication device 110 and/or 108. As such, it may be desired to communicate with cars, trucks, or other vehicles within a specific region to provide warnings, advertisements, indications, further information relating to the road, vicinity, or other aspect of the trip. By comparison, it may be desired to allow interfacing with at least one identifiable person and/or identifiable communication device 108 based on where the contacted person or communication device lives, where they indicate that they are situated, or other such context-based aspects.

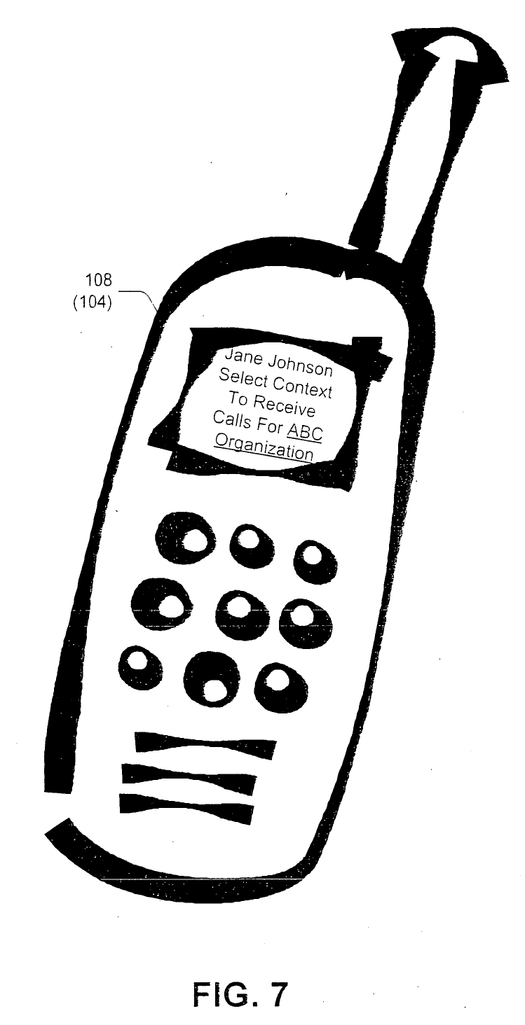

FIG. 7 shows an embodiment of the context designated destination communication system 100 in which a vehicle can be manually or automatically configured to associate a particular user(s) with the identifiable person and/or identifiable communication device 108 based on the context. For example, each person entering a vehicle can (either by manual input or automatically based on sensors, detectors, etc.) be context-associated with the vehicle. If there is some emergency, or other attempted contact to persons in the vehicle, then a communication directed to that vehicle can be directed or forwarded to at least one of those persons.

Certain embodiments of the context identifier 102 within the context designated destination communication system 100 can be configured to allow particular persons and/or communication device 108 or 110 to select their desired or appropriate interfacing level(s). For example, it may be desired to allow or enhance interfacing, communication, etc. between certain persons and/or communication device 108 and/or 110; while other persons and/or communication device 108 and/or 110 may be configured to limit communication to their context identifier for privacy, secrecy, or other concerns.

Certain embodiments of the interfacing person and/or interfacing communication device 110 and/or the identifiable person and/or identifiable communication device 108 can be configured to provide for a variety of privacy aspects. For instance, certain users of the identifiable person and/or identifiable communication device 108 and/or the at least one interfacing person and/or interfacing communication device 110 may not desire to be communicated with at certain times, under certain contexts, etc. Alternately, certain users may wish to control the contexts at which they can be contacted. Certain embodiments of the context designated destination communication system 100 can allow for a collection of one or more of those embodiments of the context identifier 102 that satisfies the context-set query to be interfaced with and/or communicated with; while others may not be interfaced with and/or be communicated with. For example, a corporate president or CEO of a multinational corporation might likely not desire to have every communication addressed to the particular corporation connected directly to their at least one identifiable person and/or identifiable communication device 108 based on an operation of the context identifier 102; while at least certain ones of such communications may be directed to a particular worker, assistant, soldier, etc. Certain embodiments of the context identifier 102 may undergo a variety of logic, weighting, selecting, or other such actions or criteria by which only certain ones of the at least one interfacing person and/or interfacing communication device 110 and/or the at least one identifiable person and/or identifiable communication device 108 which satisfy a particular context-set query will be communicated therewith. Certain embodiments of the at least one interfacing person and/or interfacing communication device 110 and/or at least one identifiable person and/or identifiable communication device 108 can be configured to allow their degree or techniques of interactivity and/or communication to be controlled and/or adjusted, based at least in part on the context identifier 102.

Conventional interfacing devices, and particularly interfacing communication devices, often have communications attempted and/or maintained based at least partially on the address of the device(s) itself. Typically, the address of the device itself remains unchanging over time regardless of where the user and/or device is situated and/or moved (e.g., a phone number for a conventional phone doesn't change). Such devices, in actuality, can be configured to follow the contacted-person or communication devices around to a variety of locations, positions, situations, etc. There can be a considerable degree of uncertainty about how to interface with a particular a user over a particular device, without initially having to determine the address (e.g., based upon the identity of its user).

This disclosure describes a variety of situations in which it may be desirable to interface between one or more of the at least one identifiable person and/or identifiable communication device 108 and/or the at least one interfacing person and/or interfacing communication device 110 based at least partially upon the at least one context of the context-dependent interfacing device(s) 108 and/or 110. Such context-based communications can pertain to such devices as telephones, computers, music and/or audio providing devices, computer-based game devices, controllers, videoconference systems, networked devices, etc. This relates, for example, to interfacing between multiple devices based on an address of the conventional interfacing devices themselves. It might therefore be desirable to communicate with at least one identifiable person and/or identifiable communication device 108 located in a vehicle situated on a particular section of roadways, highway, etc. via one or more of the at least one identifiable person and/or identifiable communication device 108 and/or the at least one interfacing person and/or interfacing communication device 110. Such address of each at least one interfacing person and/or interfacing communication device 110 can be made according to the location of the at least one identifiable person and/or identifiable communication device 108, at the particular time.

There can be a considerable variety of the at least one identifiable person and/or identifiable communication device 108 and/or the at least one interfacing person and/or interfacing communication device 110 that may be included in the least one context designated destination communication system 100. Certain embodiments of the at least one identifiable person and/or identifiable communication device 108 and/or the at least one interfacing person and/or interfacing communication device 110 may lie as a number of types of media which may include, but are not limited to: phone-type, interfacing-type, computer type, audio type, communication modalities, data type, music type, positioning system type. Certain embodiments of the at least one identifiable person and/or identifiable communication device 108 and/or the at least one interfacing person and/or interfacing communication device 110 may be expected to perform one or more overlapping functions. Examples of such overlapping functions may include, but are not limited to, as acting as a telephone, personal display assistant (PDA), a computer, an e-mail provider, a game, a locator or positioning device such as a global positioning system (GPS) device, etc. Certain embodiments of the at least one identifiable person and/or identifiable communication device 108 and/or the at least one interfacing person and/or interfacing communication device 110 may be recognized by users of computer, communication devices, control devices, and other interfacing or communication systems

It may be desirable to place a call using certain phone-type embodiments of the at least one context-dependent at least one interfacing person and/or interfacing communication device 110 to each phone, communication device, audio device, etc. of at least one identifiable person and/or identifiable communication device associated with specific vehicles, buildings, offices, companies, homes, street address locations, etc. For example, consider that a person may wish to contact any worker at a small-business, in a particular department, within a specific geographic region, and/or who performs a particular job, profession, function, or operation. As such, for instance, it may be desired to communicate with a particular professional including, but not limited to: a lawyer, an engineer, a restaurant, a plumber, an assistant, or an other person or group within a prescribed region, or having an other characteristics. A variety of such context-sets can be applied or used, such as contacting those came from particular schools, associations, colleges, geographic locations and/or regions, churches, theaters, etc. As such, it may become less important that those associated with a particular context-set that geographically remain within a particular location, building, office, etc.

For example, at least one identifiable person and/or identifiable communication device 108 may each be associated with such groups, businesses, organizations, etc. as a company, with a box office at a theater, a sporting event, a vehicle, etc. Such particular at least one identifiable person and/or identifiable communication device 108 may allow communication to be made as desired based upon that context-set user either on a full-time basis, within a range of time period(s), or with some other set of criteria.

The functionality and technology associated with certain conventional interfacing and/or communication devices have changed considerably as the devices have changed in a recent past. Consider that such devices and systems as cellular phones, e-mail, personal displays assistant (PDA), games, video systems, television systems, audio systems, videoconference systems, etc. have changed their use an application as the technology has improved. Such trends will likely continue. It is important to allow existing devices and/or technology to interface with the developing technology. For instance, it is important that people can use their existing cell phones, music and/or audio providing devices, satellite phones, hard-line phones, PDAs, computers, videoconference systems, etc. in as many embodiments of the context designated destination communication system 100 as practicable. Certain concepts and technologies as applied to relatively current phone, communication, music and/or audio providing devices, telecommunication, data-transfer, and other systems are desired to remain applicable to new generation of the at least one identifiable person and/or identifiable communication device 108, the at least one interfacing person and/or interfacing communication device 110, and/or the context identifier 102, involved, to be limited based upon the claim language into the exemplary, but not limiting, embodiments as described in this disclosure.

Such characteristics can be distinctly input by the one or more persons and/or communication device 110 and/or at least one identifiable person and/or identifiable communication device 108 can utilize a variety of input devices including, but not limited to: alphanumeric devices, keypads, graphical user interfaces (GUT), key devices, voice recognition devices, character recognition devices, etc. The complexity, usage, and sophistication of the context designated destination communication system 100, the one or more persons and/or communication device 110, and/or at least one identifiable person and/or identifiable communication device 108 can factor into the type of input contexts which each user can input as their particular context-set at least partially using their at least one identifiable person and/or identifiable communication device 108 and/or the at least one interfacing person and/or interfacing communication device 110. As such, certain of the at least one interfacing person and/or interfacing communication device 110 attempting to interface with the at least one identifiable person and/or identifiable communication device 108 can at least partially utilize a particular context or context set to at least partially establish a context-set query in attempting to contact the at least one identifiable person and/or identifiable communication device.

Those embodiments of the context designated destination communication system 100 that are phone, audio, music, and/or communication based can include communication as the interfacing mode (e.g., since phones are primarily used to allow two or more at least one identifiable person and/or identifiable communication device 108 to communicate with each other, but also for data transfer, etc.). Certain phone system embodiments of the context designated destination communication system 100 could use information about the location (or context) of phones, audio devices, or other communication devices to address them. Location of each persons and/or communication device 108 or 110 could be inferred by the infrastructure, entered by the user, acquired by the phone, audio or music device, or other communication device (or possibility other device e.g. From signals or other information at its location), or by other means. Certain addresses of each at least one identifiable person and/or identifiable communication device 108 could take the form of a class of locations with certain attributes or a label for a particular location and/or one or more at least one identifiable person and/or identifiable communication device with specific attributes within that location.

There can be a considerable variety of types, mechanisms, and/or techniques associated with such interfacing, between a variety of persons and/or communication device 108 or 110, depending on the expected use and actual use of the persons and/or communication device 108 or 110 included in the context designated destination communication system 100. For instance, certain phone, audio-transfer, data-transfer, or telecommunication embodiments of the context designated communication system 100 (which may include but are not limited to land-line phones, cellular phones, satellite phone, music and/or audio providing devices, videoconferences, etc.) would be expected to provide voice communication and/or data transfer between a number of the phones or other communication devices.

Certain embodiments of the context designated destination communication system 100 including computers as the persons and/or communication device 108 or 110 (which may include but are not limited to personal computers, laptop computers, networked computers, personal display assistants (PDAs), mainframe computers, etc.) might be expected to provide data transfer, internet communications, audio between a number of the computers. Those embodiments of the context designated destination communication system 100 including music and/or audio devices as the persons and/or communication device 108 or 110 would be expected to provide data, music, and/or audio transfer between a number of the music and/or audio devices.

Certain phone-based or other communication device-based embodiments of the context designated destination communication system 100 can thereby be configured to allow interfacing between a variety of persons and/or communication device 108 or 110 and their associated land-based phones as well movable phones (e.g., cell phones, satellite phone, videoconferences, etc.). One scenario for a phone-based embodiment of the context designated destination communication system 100, can involve one or more at least one identifiable person and/or identifiable communication device 108 associating themselves with a prescribed location such as getting into a vehicle, home, business, or other prescribed location. Thereupon the location-enabled context enabled embodiments of the persons and/or communication device 108 can configure themselves to allow at least one interfacing person and/or interfacing communication device 110 to communicate with them utilizing one of a variety of context-based information that identifies the vehicle.

Such context-based information can include, but is not limited to: attributes of the car, building, etc., such as but not limited to: license plate, type, global positioning system (GPS) location, etc. Such context information is made available to the network so that another persons and/or communication device 108 or 110 can, for example “call someone at the prescribed location (e.g.) having a particular context such as particular context license plate for a car; a particular context designated destination or location for a building, home, or office, etc., a particular context email or name for a business, etc. With certain embodiments of the context designated destination communication system 100, the at least one interfacing person and/or interfacing communication device 110 could obtain context-based information based at least in part on recognition of a captured image (e.g., of a license plate, person, address, etc.). As such, a communication could be made either by inputting the license plate number of the vehicle by, for example: pressing the keypad, dial the license number when prompted, taking a photo of the plates of the vehicle or address of the building, home, etc., such as the car that can be recognized. Thereupon, and the at least one interfacing person and/or interfacing communication device 110 can thereupon select to make the communication such as a phone call, data-transfer, information transfer, and/or some other similar technique.

Certain embodiments of the context designated destination communication system 100 can, depending on context, provide for calling phones (e.g., including cell phones, satellite phone, videoconference, etc.) in each moving car, truck, ship, aircraft, etc. within a particular region, such as a section of highway, waterway, airway, etc. For example, certain positional-enabled embodiments of the context designated destination communication system 100 would be able to determine which cars are within the area of highway based on a positional (e.g., global positioning system, or GPS) interrogation to determine which vehicles are within the particular region, for example. A number of conventional cell phones, satellite phone, music and/or audio providing devices, videoconferences, for example, include GPS or other positional devices that could be utilized by the context designated destination communication system 100 to provide such context-based information as positional information.

Certain embodiments of the context designated destination communication system 100 can, depending on context, provide for calling a phone or other communication device in a. building or house or in a particular location or class of locations. For example, it may be desirable to call all phones or other communication devices associated with individuals located in, or trapped in elevators, buildings, etc.

Certain embodiments of the context designated destination communication system 100 can, depending on context, provide for interfacing by a number of at least one identifiable person and/or identifiable communication device 109 and/or the at least one interfacing person and/or interfacing communication device 110 associated with many large or small retail businesses or organization (e.g. Call Starbucks®, Sears®, or other retailer). Such business-related context designated destination communication system 100 would allow consumers, associates, clients, etc. to interface effectively with the business or organization; or just reduce ambiguity of interfacing using call lookup based at least partially on location. For example, it might be desired to contact a phone or other communication device in a building or house or in a particular location or class of locations (e.g., call the at least one identifiable person and/or identifiable communication device 108 in the elevators in a building; contacting the at least one identifiable person and/or identifiable communication device 108 at an address or small retail businesses. Or alternately, disambiguating a call lookup by location such as by contacting a known store, restaurant, service provider, etc. at a particular location, or within a specified region.

Certain embodiments of the context designated destination communication system 100 can, depending on context, provide for allowing interfacing between the at least one identifiable person and/or identifiable communication device 108 and/or the at least one interfacing person and/or interfacing communication device 110 if the at least one interfacing person and/or interfacing communication device knows some characteristic of the at least one identifiable person and/or identifiable communication device. For instance, the at least one identifiable person and/or identifiable communication device may be characterized by some context, such as to allow for a communication to a particular individual, an individual from a business or organization, a person having a particular appearance or wearing some identifiable clothes, etc.

For example, certain embodiments of the context designated destination communication system 100 can allow a call to be made to “the guy in the black sweater” at a particular location, or in a particular vehicle or building, etc. Input to the calling process could in certain embodiments also be at least partially photographic. As such, the at least one interfacing person and/or interfacing communication device 110 could capture or image an image of the at least one identifiable person and/or identifiable communication device 108, and the location of the capturing (photographing) could be used to determine at least one of the context (location and appearance) of the at least one identifiable person and/or identifiable communication device 108. The at least one identifiable person and/or identifiable communication device 108 could thereupon indicate to set up the communication such as by pressing call, and the context designated destination communication system 100 would thereupon set up communications with the at least one identifiable person and/or identifiable communication device 108. In certain embodiments of the at least one identifiable person and/or identifiable communication device 108, for example, the communication could be indicated as being either context-based, or via conventional mechanisms (e.g., call set-up, and ringer signals).

Certain embodiments of a context set can include one context, or alternately a number thereof. For instance, a communication can be established to one or more of a particular person, belonging to a particular organization or company, traveling on a particular vehicle such as a train, bus, or aircraft, at a particular location, etc. Certain embodiments of the context designated destination communication system 100 might allow control of particular at least one identifiable person and/or identifiable communication device 108 that satisfy the at least one context.

For example, if there are multiple phones or other communication devices that are actuated within a vehicle or building, etc., then if a communication is being placed to a first at least one identifiable person and/or identifiable communication device 108, which thereupon rejects the communication. Thereupon, a second communication (e.g., prompt-driven or automatic) may be provided to other at least one identifiable person and/or identifiable communication device 108 that satisfy the at least one context. For instance, in a car example, a communication that can be directed to the driver may be indicated as being busy driving, and thereby rejected. Such a rejected communication signal might trigger an attempt to call another at least one identifiable person and/or identifiable communication device 108 in the car. As such, certain at least one interfacing person and/or interfacing communication device 110 might be given an option (upon receipt of a busy signal), to “transfer locally” or even see a list of the other phones or other communication devices in the location specified by the caller to which a user could transfer.

### 2. Context Associating

Certain embodiments of the context designated destination communication system 100, as described with respect to FIGS. 1 and/or 2, can therefore attempt to establish and/or establish communication between certain embodiments of the communication devices 110 and/or 108 based at least in part on a particular context (e.g. relating to the identifiable person and/or identifiable communication device 108). Certain embodiments of such context-based communications, and establishing communications, can rely upon one more of the context identifier 102, the context associator 104, the context designated destination registry 112, and/or the context designated destination communication mechanism 99. As such, certain potential interactions between certain embodiments of the context identifier 102, the context associator 104, and/or the context designated destination communication mechanism 99 may occur as now described in this disclosure, or derivations or modifications thereof.

Certain embodiments of the context associator 104, which may be included in and/or associated with the identifiable person and/or identifiable communication device 108 and/or the context designated destination communication mechanism 99, can be configured to establish and associate at least one of the context with the at least one identifiable person and/or identifiable communication device 108. As such, certain embodiments of the context associator 104 can be used to select which context in which the identifiable person and/or identifiable communication device 108 will be configured to communicate, or receive attempted communications-based thereupon. Additionally, certain embodiment of the context associator 104 can determine whether one, or multiple, of the identifiable person and/or identifiable communication device 108 will be attempted to be communicated therewith, or be communicated therewith, based at least in part on at least one context. Such establishing or attempting to establish communications based at least partially on the context can be used to dictate when, under what circumstances, and under which instances, communications with the at least one identifiable person and/or identifiable communication device 108 can be established and maintained.

Certain embodiments of the context designated destination communication system 100, as described with respect to FIG. 5, can thereby at least partially use the context associator 104, to establish or attempt a communication with the identifiable person and/or identifiable communication device 108 based at least partially on the context. Certain embodiments of the associating the context can be at least partially derived by the presence of the identifiable person and/or identifiable communication device 108 based lease partially on the context such as, but not limited to: at a desired location, within a particular region, relative to a particular vehicle, relative to a particular physical structure, building, or dwelling, etc. For example, a user of certain embodiments of the context designated destination communication system 100 who works for a particular company can have their identifiable communication device 108 actuated as they, enter the building, room, office, or other employment location, or other such activity by whose presence or association can indicate the context has been satisfied. As such, at least certain of the communications and/or attempt a communications that satisfy the context should be directed to the at least one identifiable person and/or identifiable communication device 108.

While the FIG. 5 embodiment of the context associator 104 may be applied to a distinct device such as a computer (e.g., work-based) from the identifiable person and/or identifiable communication device 108, it may be envisioned that certain embodiments of the context associator can be configured as a portion of, or integrated with, and/or associated with certain embodiments of the identifiable person and/or identifiable communication device 108. For example, FIG. A1 shows an illustrative, but not-limiting, embodiment of the context associator 104 as associated with (e.g., integrated within) a cell-phone or other communication device embodiment of the identifiable person and/or identifiable communication device 108. In this configuration, for example, the user (e.g., Jane Johnson, as illustrated with respect to FIG. A1) can select to receive communications directed to her from another context such as if she was able to be reached via a work context, or associated with a particular organizational context. Operationally, certain embodiments of the context associator 104 can be configured, or structured, to operate in a similar manner as call forwarding. As such, when a particular communication are attempted communication is directed to a particular context, and certain embodiments of the identifiable person and/or identifiable communication device 108 are associated with the context, then a particular communication are attempted communication may be forwarded to the identifiable person and/or identifiable communication device 108 to satisfy, the context. With certain embodiments of the context associator 104, the user can thereby select those contexts for which they can receive communications, providing that the identifiable person and/or identifiable communication device 108 satisfies the particular privacy, organizational, or other criteria for the particular context. When certain persons or users become associated with at least one identifiable person and/or identifiable communication device 108 based at least partially on a context, then at least some of the further communications that may be directed based on the context may be received by the at least one identifiable person and/or identifiable communication device 108. While the embodiment of the context associator 104, as described with respect to FIG. 5, is manually operated, certain embodiments of the context associator 104 can be at least partially automated.

Certain types of data, information, signals, etc. relied at least partially upon during the associating the context of the at least one identifiable person and/or identifiable communication device 108 can be transferred (e.g., to at least one interfacing person and/or interfacing communication device 110 and/or an intermediate device) by various networks, communication devices, devices, etc. to the at least one addressing communication mechanism 98 and/or the context designated destination communication mechanism 99. Certain embodiments of the context designated destination communication mechanism 99 can thereupon include network is well as memory or database characteristics, and thereby can obtain, store, process, transfer, and/or otherwise handle communications within the context designated destination communication system 100 based at least partially on the context.

One application of the context designated destination communication system 100 is the professional, medical, and/or research area. In such areas, a number of users are often “on the go”, which means that they are often difficult to reach by their direct number. In such instances, the user of certain embodiments of the identifiable person and/or identifiable communication device 108, such as a doctor, a professional, a researcher, etc., can provide select a context by which they can be reached at their at least one identifiable person and/or identifiable communication device 108. For instance, a doctor may be situated in an operating room similar to as illustrated relative to FIG. A3. The doctor, or other such user of the identifiable person and/or identifiable communication device 108, can utilize the context associator 104 to allow at least certain communications to be directed to them based at least partially on the context. For instance, emergency communications can be directed to certain embodiments of the identifiable person and/or identifiable communication device 108, such as their cell phone, there land-line, their PDA, or an operating-room audio system that represents different embodiments of the identifiable person and/or identifiable communication device 108.

Also, certain individuals entering a vehicle, physical structure, building, office, dwelling, etc. can allow, establishing the context in the identifiable person and/or identifiable communication device 108 at least partially automatically. Certain establishing of context by certain embodiments of the identifiable person and/or identifiable communication device 108 can be based lease partially on a position, location, situation, or other aspect of the identifiable person and/or identifiable communication device 108. For example, the context of certain embodiments of the identifiable person and/or identifiable communication device 108 can be established at least partially by using an automated detector or a sensor that can sense the presence or location of the identifiable person and/or identifiable communication device 108. Upon sensing the presence and/or location of the identifiable person and/or identifiable communication device 108, for example, certain embodiments of the context associator 104 can automatically associate the at least one-identifiable person and/or identifiable communication device 108 with a particular context. Proximity sensors, positional sensors, location centers, etc. Can be used by certain embodiments of the identifiable person and/or identifiable communication device 108 to provide certain embodiments of positional-based context information. Such positional-based context information can provide such information as where such communication devices 108 and/or 110 are situated, movement of such communication devices 108 and/or 110, etc.

Certain embodiments of the context designated destination communication system 100, as described with respect to FIG. 5, can allow establishing and/or maintaining a context that can be used to attempt or maintain communication with the identifiable person and/or identifiable communication device 108 from a device that may be separate from, or not even operationally associated with, the identifiable communication device 108. Certain instances of such establishing and/or maintaining the context can be preformed at least partially manually by input of a user to the identifiable person and/or identifiable communication device 108. For example, certain identifiable person and/or identifiable communication device 108 can configure a context relative to their identifiable person and/or identifiable communication device 108 based at least in part on input to a graphical user interface (GUI) such as over a computer monitor or display, a switch, a controller, an actuator, etc. FIG. 5, for instance, is configured to allow a user of the identifiable person and/or identifiable communication device 108 to interface with the GUI version of the context associator 104, which can be, for example, associated over a distinct (but related) device. For instance, the user of certain embodiments of the identifiable person and/or identifiable communication device 108 can configure their identifiable person and/or identifiable communication device 108 based at least in part on input via the context designated destination communication mechanism 99, such that at least certain communications directed to the context, such as a context phone number (for example, a number associated with particular organization or corporate department, etc.) may be directed to the identifiable person and/or identifiable communication device 108, when so actuated.

Certain context embodiments of the context associator 104 can be actuated as selected from a remote location as described with respect to FIG. 5. As such, a person could use their identifiable person and/or identifiable communication device 108 (including the context associator 104) to communicate with others as if they were located at a site, at a company, in a medical center, and doctors office, etc. Such configurations could further enhance the effectiveness of people working from home. For example, certain attended communications directed by the interfacing person and/or interfacing communication device 110 to the identifiable person and/or identifiable communication device 108 can be afforded, based on an associated context, to other devices, etc. As such, people could respond to phone calls, music and/or audio, or other communications addressed to them that are re-directed or routed there to based on a context (and not simply call forwarding) at work, home, in a vehicle, or at some other location.

A variety of menus, graphical user interfaces (GUIs), switches, hardware devices, software devices, and/or firmware devices can be included in, or operationally associated with, the at least one identifiable person and/or identifiable communication device 108. For instance, computer GUIs, menus, or other input/output devices, phone-based GUIs, menus, pressbuttons, or other input/output devices, etc. can be used as certain manual devices that can select under which context(s) the at least one identifiable person and/or identifiable communication device 108 can be contacted.

Certain embodiments of the context designated destination communication system 100 can be configured to provide privacy and/or security for at least certain ones of the at least one identifiable person and/or identifiable communication device 108 and/or at least one interfacing person and/or interfacing communication device 110. Certain persons going to work on a particular department of operation and/or company may, for example, now wish to receive all, or even certain, communications that are directed toward a particular context-associated department, company, and/or organization. Certain privacy-based filtering, or otherwise privacy-based limiting, techniques can be used to limit communications from certain interfacing person and/or interfacing communication device 110 that are based at least partially on one or more context. As such, privacy and/or security aspects can be applied to certain embodiments of the identifiable person and/or identifiable communication device 108 as well a certain embodiments of the interfacing person and/or interfacing communication device 110.

In addition, certain embodiments of the context designated destination registry 112 can be a configured to limit communications between one or more of the identifiable person and/or identifiable communication device 108 and/or the interfacing person and/or interfacing communication device 110 based at least partially on privacy aspects. As mentioned in this disclosure, certain embodiments of the context designated destination registry 112 can be configured to translate from addressed-based communications to context-based communications. Certain embodiments of the context designated destination registry 112 can also be configured to limit, control, or filter certain translations, communications, or attempt communications such as may be associated with certain contexts and/or certain ones of the identifiable person and/or identifiable communication device 108 and/or interfacing person and/or interfacing communication device 110. For instance, certain embodiments of the context designated destination communication system 100 may be configured to direct a particular context-based communication, or attempted context-based communication, to the identifiable person and/or identifiable communication device 108 may be associated with a particular doctor, professional, individual, business, organization, etc. Certain embodiments of the context designated destination registry 112 can be there to allow only certain ones of these communications and/or attempt communications to pass to at least certain of the identifiable person and/or identifiable communication device 108, and can thereby filter out other undesirable, unsuitable, or unintended communications as desired.

Certain embodiments of the at least one identifiable person and/or identifiable communication device 108 and/or al least one interfacing person and/or interfacing communication device 110 can be configured as either conventional devices (e.g., cell phones, satellite phones, etc.). As such, the at least one identifiable person and/or identifiable communication device 108 and/or the at least one interfacing person and/or interfacing communication device 110 may not even be aware whether the device is at least partially utilizing certain embodiments of the context designated destination communication system 100 or is operating on an otherwise conventional network or communication system. Certain embodiments of the identifiable person and/or identifiable communication device 108 and/or the interfacing person and/or interfacing communication device 110 can utilize an integrated portion, or have an additional portion which allows for the functionality and/or interaction of the context designated destination communication mechanism 99.

Certain embodiments of the context designated destination communication mechanism 99 can be configured to allow establishing communications between certain ones of the at least one identifiable person and/or identifiable communication device 108 and/or at least one interfacing person and/or interfacing communication device 110 based at least in part on context, as described throughout this disclosure. Certain embodiments of the context designated destination communication mechanism 99 can be configured to operate based on hardware, software, firmware, electromechanical, switching, communication, networking, telecommunications, data-transfer, or other aspects, as generally understood in the communication technologies.

Certain embodiments of the context identifier 102, the context associator 104, and/or the context designated destination registry 112 can thereby be configured as hardware, software, or firmware. Certain embodiments of the interfacing person and/or interfacing communication device 110 are configured as conventional phones (e.g., land lines, sell, satellite could, or other) they can communicate with other devices by placing the call using conventional telecommunication, data-transfer, VOIP, sell, satellite, landline, or other technologies.

FIG. 6 shows a generalized flow chart of one embodiments of the context designated destination communication mechanism 99, which can include, but are not limited to, at lest some of processes 502, 504, 506, and/or 508. One embodiment of the process 502 shows at least one identifiable person and/or identifiable communication device 108 interfacing with certain embodiments of the context associator 104. For example, a person or a communication device could provide input to certain embodiments of the context associator 104 that is a portion of, associated with, and/or separate from the at least one identifiable person and/or identifiable communication device 108. Such input to certain embodiments of the context associator 104, as described with respect to FIG. 5, can be at least partially manual or automatic.

Certain embodiments of the process 504 relate to establishing and/or maintaining a context-based relation between multiple ones of the interfacing person and/or interfacing communication device 110 and/or the identifiable person and/or identifiable communication device 108. For example, certain embodiments of the at least one identifiable person and/or identifiable communication device 108 and/or interfacing person and/or interfacing communication device 110 can establish and/or maintain a communication therebetween at least partially based on a context. Such communications can be at least partially automatically configured or established; and/or at least partially manually configured or established.

Certain embodiments of the process 506 shows receiving a context-based connection request or query from one more of the at least one interfacing person and/or interfacing communication device 110. For example, certain embodiments of the at least one interfacing person and/or interfacing communication device 110 attempts to communicates with at least one identifiable person and/or identifiable communication device 108 based at least partially on a context of the identifiable person and/or identifiable communication device 108, as may be selected by the context associator 104.

Certain embodiment of the process 508 show attempting or establishing a context-based communication to a suitable at least one identifiable person and/or identifiable communication device 108 in a manner that can satisfy the context. For instance, a one-way or two-way communication may be established between certain embodiments of the at least one interfacing person and/or interfacing communication device 110 and/or the identifiable person and/or identifiable communication device 108, as described in this disclosure.

With certain embodiments of the context designated destination communication system 100, the context can be at least partially provided from the context identifier 102. Certain embodiment of the context identifier 102 may be, for example, either associated with or discrete from, the context identifier 102. As such, certain embodiments of the context identifier 102 can allow the attempting and/or maintaining communication between the identifiable person and/or identifiable communication device 108 and/or the interfacing person and/or interfacing communication device 110.

Certain embodiments of the context designated destination communication mechanism 99 can act to determine which of the at least one interfacing person and/or interfacing communication device 110 and/or the at least one identifiable person and/or identifiable communication device 108 can satisfy the query. Certain embodiments of the context designated destination communication mechanism 99 can therefore be configured to establish and/or maintain communications between the at least one interfacing person and/or interfacing communication device 110 and/or the at least one identifiable person and/or identifiable communication device 108.

### 3. Context Identifying

As described through various portions of this disclosure, certain embodiments of the at least one context designated destination can be at least partially designated by a context that is at least partially associated using the context associator 104 that may be operationally associated with the at least one identifiable person and/or identifiable communication device 108. Certain embodiments of the at least one context designated destination can be at least partially maintained in one or more a variety of forms within the context designated destination communication mechanism 99, such as in data, information, text, or other such format within the context designated destination registry 112 and/or the context designated destination controller 97.

Certain embodiments of the at least one context designated destination communication mechanism 99 as described with respect to FIGS. 1 and 2, and other locations through the disclosure, are configured to provide for communication between the at least one interfacing person and/or interfacing communication device 110 and the identifiable person and/or identifiable communication device 108 based, at least in part, on the context (e.g., the at least one context designated destination). For instance, following the establishing of the context, certain embodiments of the at least one interfacing person and/or interfacing communication device 110 may attempt to communicate to another device via the context (e.g., the at least one context designated destination). Thereupon, certain embodiments of the context identifier 102 can attempt to provide at least one context-based communicate, such as dialing a phone number as proxy of the at least one interfacing person and/or interfacing communication device 110 that corresponds to the context (e.g., the at least one context designated destination). Thereupon, the communication can be attempted, or provided, between the at least one interfacing person and/or interfacing communication device 110 and the identifiable person and/or identifiable communication device 108 based at least partially on context.

Certain embodiments of the at least one context identifier 102 can thereby interface with the at least one context associator 104 to associate and/or identify communications based at least partially on context (e.g., the at least one context designated destination). For example, with a phone-based embodiment of the context designated destination communication system 100, certain embodiments of the interfacing person and/or interfacing communication device 110 can place a call using a phone number, or other context designated destination, and at least one identifiable person and/or identifiable communication device 108 that corresponds to the at least one context designated destination will be contacted such as by transmitting a ringing signal to the other device. For example, those of the identifiable person and/or identifiable communication device 108 that satisfy the at least one context designated destination can be contacted, such as providing a ringing signal thereto. The use of ringing signals to cause such attempted communication as by causing phones to ring is generally understood and will not be further described in this disclosure.

Since each particular context (e.g., the at least one context designated destination) may be associated with one or more of the at least one identifiable person and/or identifiable communication device 108, it is possible for more than one identifiable person and/or identifiable communication device 108 to be contacted during each attempted communication. For example, assuming that a particular context pertains to a medical center, a business, a division, an organization, or even a vehicle, then a considerable number of the at least one identifiable person and/or identifiable communication device 108 could potentially be contacted. Depending on the configuration of the context designated destination communication system 100, the number of applicable identifiable person and/or identifiable communication device 108, the organization criteria, type of communication, settings, and/or privacy considerations of the organization, business, vehicle, etc. associated with the context; all of the or only certain ones of the actuated identifiable person and/or identifiable communication device 108 may be attempted to be communicated therewith.

Certain embodiments of the context identifier 102 can associate with certain embodiments of the context designated destination registry 112 (as described with respect to FIGS. 1 and 2) to provide for a translation between the interfacing context and the identifiable context, as described with respect to FIG. 13 in this disclosure.

### 4. Context Designated Destination Controller

This disclosure describes a number of embodiments of the context designated destination controller 97 as described with respect to FIGS. 1 and/or 2, and at other locations through this disclosure. The various embodiments of the context designated destination controller 97 is intended to control operations within the context designated destination communication system 100 of at least the portion of the at least one identifiable person and/or identifiable communication device 108 and/or the at least one interfacing person and/or interfacing communication device 110. As such, certain embodiments of the context designated destination communication system 100 can operate without, and/or with little interaction from, the context designated destination controller 97. By comparison, certain embodiments of the context designated destination communication system 100 can utilize considerable input from, and/or entirely utilizing input from, the context designated destination controller 97.

At least some of the imaging information, data, images, signals, etc. that may be associated with certain embodiments of the context designated destination communication system 100 and/or the context designated destination controller 97 may be digital based, while at least some of other embodiments may be analog based. For instance, certain embodiments of the context designated destination communication system 100 including the context designated destination controller 97, which are largely digital and/or microprocessor-based, can provide for largely automated actuation of the context designated destination communication system 100. A number of the components of the context designated destination communication system 100 may rely on analog and/or digital controllers and/or computers which may be capable of generating signals with considerable power. Other lower-powered signals, from the context designated destination communication system 100, may be either analog and/or digitally controlled. Certain context designated destination controller 97 that are configured to turn particular circuits on or off, for example, may be particularly efficient and/or effective if digital based. Certain embodiments of the context designated destination controller 97 can be configured to, upon a normal operation, compensate for at least some distortion as can be provided by the imaging region of the person or computer. FIGS. 1 and/or 2 can thereby be considered to represent a block diagram of certain respective embodiments of the context designated destination communication system 100 that can include the context designated destination controller 97 to either control and/or adjust the operation of the context designated destination communication system, or some other related operations.

Certain embodiments of the context designated destination controller 97 are configured to provide control and/or adjustability of the context designated destination communication system 100 based, at least in part, on the operation and/or configuration of the context designated destination communication system. For example, the user could provide suitable input to the context designated destination controller 97. Such input to the context designated destination controller 97 can be provided via the input/output interface, which in certain embodiments may be a graphical user interface (GUI), for example.

Certain embodiments of the at least one identifiable person and/or identifiable communication device 108 and/or at least one interfacing person and/or interfacing communication device 110 may be configured to operate within context designated destination communication system 100 on a real time basis, a continuous basis, a sequential basis, or another repetitive basis. As such, the type of communications and/or attempted communications can also be selected using the input/output interface 811 of certain embodiments of the context designated destination controller 97.

Certain embodiments of the context designated destination communication system 100 can thereby include, but are not limited to, a variety of configurations of the context designated destination controller 97. Certain embodiments of the context designated destination controller 97 can also be at least partially computer based, controller based, mote based, cellular telephone-based, and/or electronics based. Certain embodiments of the context designated destination controller can be segmented into modules, and can utilize a variety of wireless interfacings and/or networking technologies to allow information, data, etc. to be transferred to the various distinct portions or embodiments of the context designated destination communication system 100. Certain embodiments of the context designated destination controller 97 can be configured as a unitary device, a networked device, or a stand alone device.

Certain embodiments of the context designated destination controller 97 can vary as to the level of their automation, complexity, and/or sophistication; and can be utilized to control, setup, establish, and/or maintain interfacings between a number of communicating devices during operation(s). As described within this disclosure, multiple ones of the different embodiments of the context designated destination communication system 100 can transfer information or data relating to the interfacing link to or from a remote location and/or some intermediate device as might be associated with interfacing, monitoring and/or other activities.

Certain embodiments of the context designated destination controller 97, as well as certain embodiments of the context designated destination communication system 100 (in general), can utilize distinct firmware, hardware, and/or software technology. For example, certain embodiments of the context designated destination controller 97 can utilize mote-based technology, microprocessor-based technology, microcomputer-based technology, general-purpose computer technology, specific-purpose computer technology, Application-Specific Integrated Circuits (AASICs), and/or a variety of other computer technologies can be utilized for certain embodiments of the context designated destination controller 97, as well as certain embodiments of the context designated destination communication system 100.

Certain embodiments of the context designated destination controller 97 can as described with respect to FIGS. 1 and/or 2 can include depending on context a processor such as a central processing unit (CPU), a memory 807, a circuit or circuit portion 809, and an input output interface (I/O) 811 that may include a bus (not shown). Certain embodiments of the context designated destination controller 97 of the context designated destination communication system 100 can include and/or be a portion of a general-purpose computer, a specific-purpose computer, a microprocessor, a microcontroller, a personal display assistant (PDA), a cellular phone, a wireless communicating device, a hard-wired interfacing device, and/or any other known suitable type of interfacings device or phone, computer, and/or controller that can be implemented in hardware, software, electromechanical devices, and/or firmware. Certain embodiments of the processor 803, as described with respect to FIGS. 1 and/or 2, can perform the processing and arithmetic operations for certain embodiments of the context designated destination controller 97 of the context designated destination communication system 100. Certain embodiments of the context designated destination controller 97 of the context designated destination communication system 100 can control the signal processing, database querying and response, computational, timing, data transfer, and other processes such as can be adjusted by and/or controlled by certain embodiments of the context designated destination controller 97 of the context designated destination communication system 100.

Certain embodiments of the components of the context designated destination controller 97 can be at least partially operationally associated with or integrated in, as described with respect to FIGS. 1, 2, and other locations in this disclosure, the at least one context associator 104, the at least one context identifier 102, and/or the at least one context designated destination registry 112. As such, the various components of the context designated destination controller 97 can be arranged to provide communication between the at least one interfacing person and/or interfacing communication device 110 and the at least one identifiable person and/or identifiable communication device 108.

Certain embodiments of the context designated destination controller 97 (depending in part of the process being attempted or performed by the context designated destination communication system 100), will undergo considerable image processing by the processor 803. Particularly, those embodiments of the context designated destination communication system 100 that depth visualize a relatively large area, image to relatively high resolution, image continuously, sequentially, and/or repetitively will provide a large amount of images or image information. As such, certain embodiments of the components of the context designated destination controller 97 should be designed and configured to handle the type of operation. Certain types of data compression/decompression techniques (e.g., lossy and/or lossless data compression techniques) may be utilized in the context designated destination controller 97 to limit production or storage of excessive volumes of redundant data.

Certain embodiments of the memory 807 of the context designated destination controller 97 can include a random access memory (RAM) and/or read only memory (ROM) that together can store the computer programs, operands, and other parameters that control the operation of certain embodiments of the context designated destination controller 97 of the context designated destination communication system 100. The memory 807 can be configurable to contain data, images, image information, etc. that can be obtained, retained, or captured by that particular context designated destination controller 97, as described in this disclosure.

Certain embodiments of the bus can be configurable to provide for digital information transmissions between the processor 803, circuits 809, memory 807, I/O 811, the depth visualize memory or storage device (which may be integrated or removable), other portions within the context designated destination communication system 100, and/or other portions outside of the context designated destination communication system 100. In this disclosure, the memory 807 can be configurable as RAM, flash memory, semiconductor-based memory, of any other type of memory that can be configurable to store data pertaining to depth visualizes. Certain embodiments of the bus can also connects I/O 811 to the portions of certain embodiments of the context designated destination controller 97 of either the context designated destination communication system 100 that can either receive digital information from, or transmit digital information to other portions of the context designated destination communication system 100, or other systems and/or networking components associated therewith.

Certain embodiments of the context designated destination controller 97 of the context designated destination communication system 100, as described with respect to FIGS. 1 and/or 2, can include a transmitter portion (not shown) that can be either included as a portion of certain embodiments of the context designated destination controller 97 of the context designated destination communication system 100. Certain embodiments of the context designated destination controller 97 can alternately be provided as a separate unit (e.g., microprocessor-based). In certain embodiments, the transmitter portion can transmit depth visualize information between certain embodiments of the context designated destination controller 97 of the context designated destination communication system 100.

Certain embodiments of the context designated destination controller 97 of the context designated destination communication system 100 as described with respect to FIGS. 1 and/or 2 can include an operation altering portion (not shown) that can be either included as a portion of certain embodiments of the context designated destination controller 97 of the context designated destination communication system 100, or alternately can be provided as a separate unit (e.g., microprocessor-based).

Certain embodiments of the memory 807 can provide an example of a memory storage portion. In certain embodiments, the monitored value includes but is not limited to: a percentage of the memory 807, an indication of data that is or can be stored in the memory 807, or for data storage. To provide for overflow ability for the memory 807 of certain embodiments of the context designated destination controller 97 of the context designated destination communication system 100, a secondary storage device can be operably coupled to the memory 807 to allow a controllable transmitting of memory data from certain embodiments of the context designated destination controller 97 of the context designated destination communication system 100 when the monitored value of data or other information within the memory 807 exceeds a prescribed value. The prescribed value can include, e.g., some percentage amount or some actual amount of the value.

In certain embodiments, a secondary interfacing link can be established between the certain embodiments of the context designated destination controller 97 of the context designated destination communication system 100. The secondary interfacing link can be structured similar to as a interfacing link, or alternatively can utilize network-based computer connections, Internet connections, etc. to provide information and/or data transfer between certain embodiments of the context designated destination controller 97 of the context designated destination communication system 100.

In certain embodiments of the context designated destination controller 97 of the context designated destination communication system 100, the particular elements of certain embodiments of the context designated destination controller 97 of the context designated destination communication system 100 (e.g., the processor 803, the memory 807, the circuits 809, and/or the I/O 811) can provide a monitoring function to convert raw data as displayed by an indicator. A monitoring function as provided by certain embodiments of the context designated destination controller 97 of the context designated destination communication system 100 can be compared to a prescribed limit, such as whether the number of depth visualizes contained in the memory 807, the amount of data contained within the memory 807, or some other measure relating to the memory is approaching some value. The limits to the value can, in different embodiments, be controlled by the user or the manufacturer of certain embodiments of the context designated destination controller 97 of the context designated destination communication system 100. In certain embodiments, the memory 807 can store such information as data, information, displayable information, readable text, motion depth visualizes, video depth visualizes, and/or audio depth visualizes, etc.

In certain embodiments, the I/O 811 provides an interface to control the transmissions of digital information between each of the components in certain embodiments of the context designated destination controller 97 of the context designated destination communication system 100. The I/O 811 also provides an interface between the components of certain embodiments of the context designated destination controller 97 of the context designated destination communication system 100. The circuits 809 can include such other user interface devices as a display and/or a keyboard. In other embodiments, the context designated destination controller 97 of the context designated destination communication system 100 can be constructed as a specific-purpose computer such as an application-specific integrated circuit (ASIC), a microprocessor, a microcomputer, or other similar devices.

### 5. Certain Embodiments of the Context Designated Destination Communication System, the Context Designated Destination Controller, With Associated Flowcharts

Within the disclosure, flow charts of the type described in this disclosure apply to method steps as performed bad a computer or controller as could be contained within certain embodiments of the context designated destination communication system 100, as described in this disclosure. Additionally, the flow charts as described in this disclosure apply operations or procedures that can be performed entirely and/or largely utilizing mechanical devices, electromechanical devices, or the like, such as certain embodiments of the context designated destination communication system 100 as described in this disclosure. The flow charts can also apply to apparatus devices, such as an antenna or a node associated therewith that can include, (e.g., a general-purpose computer or specialized-purpose computer whose structure along with the software, firmware, electro-mechanical devices, and/or hardware, can perform the process or technique described in the flow chart).

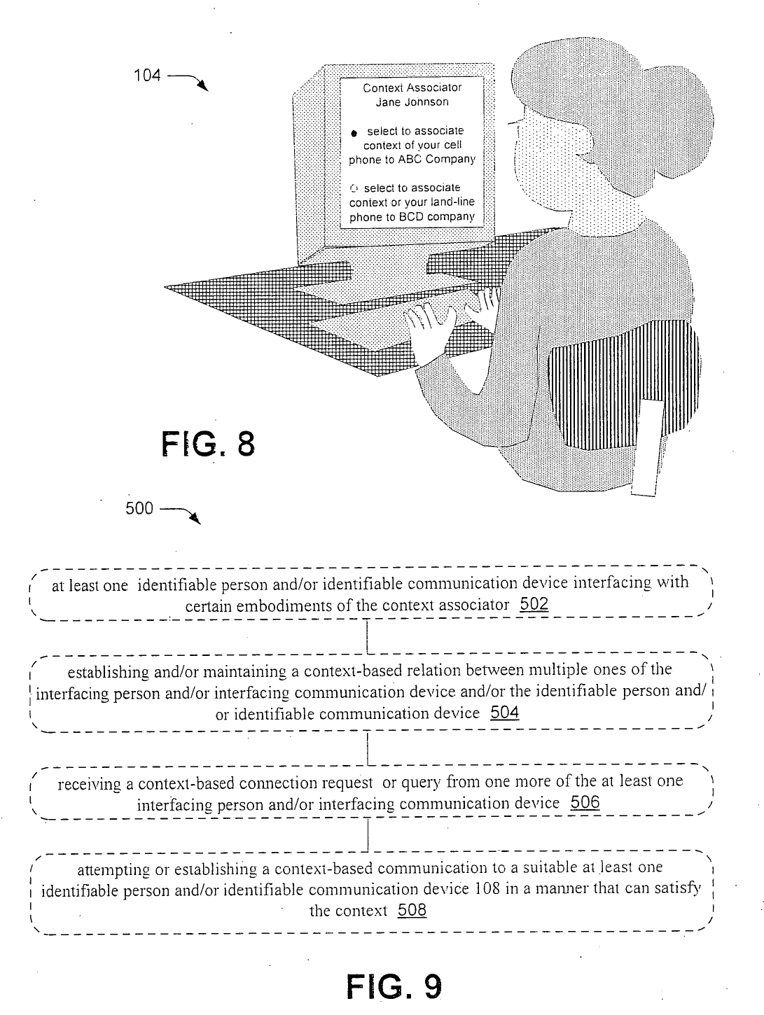

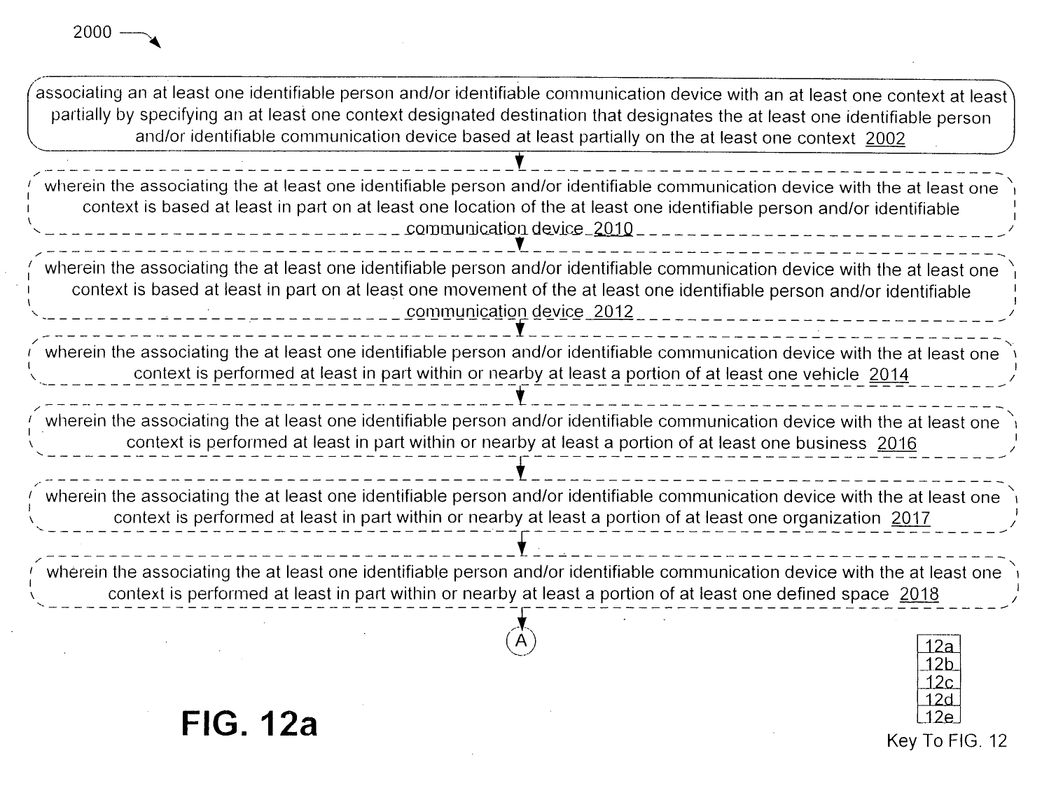

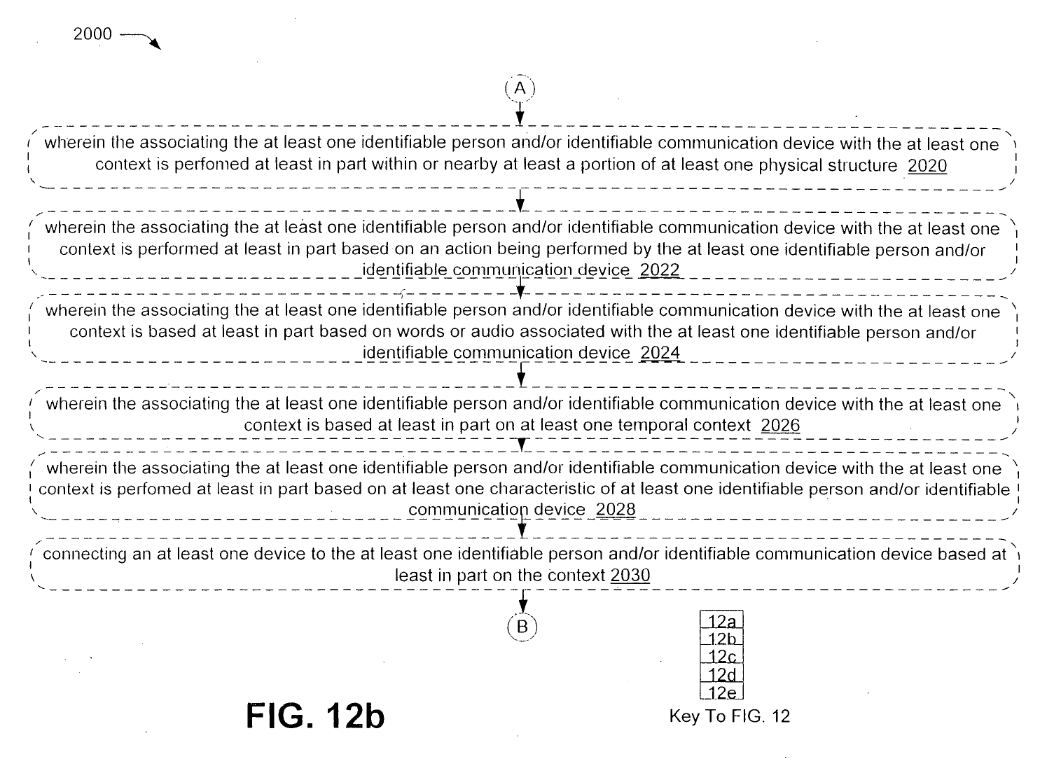

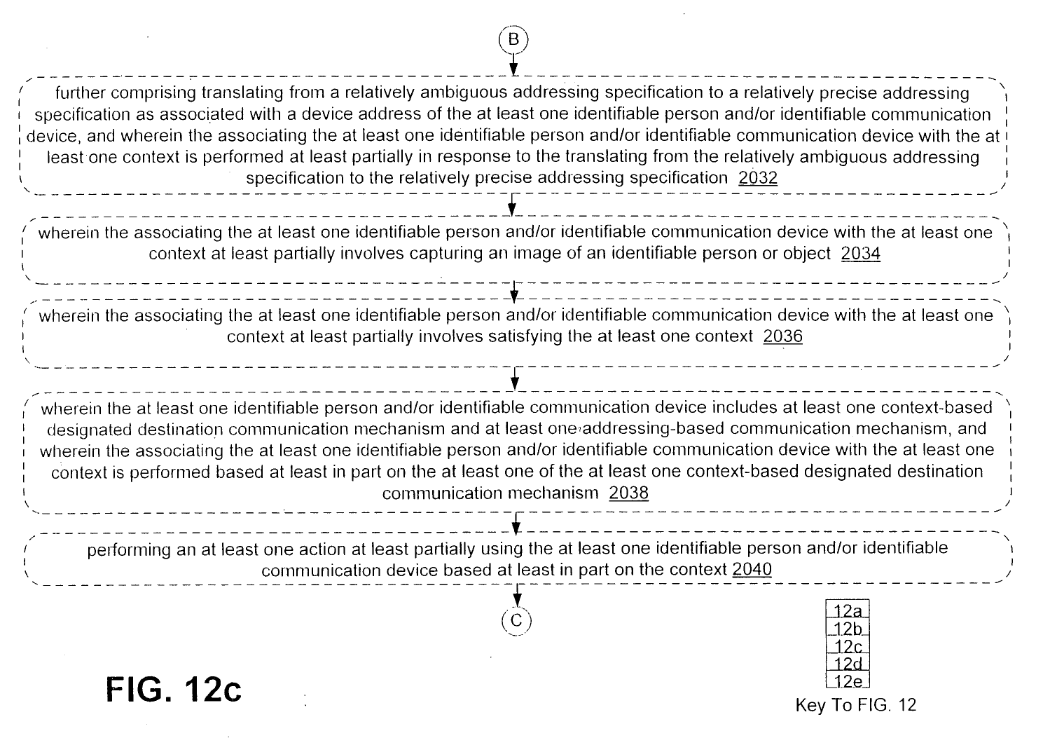

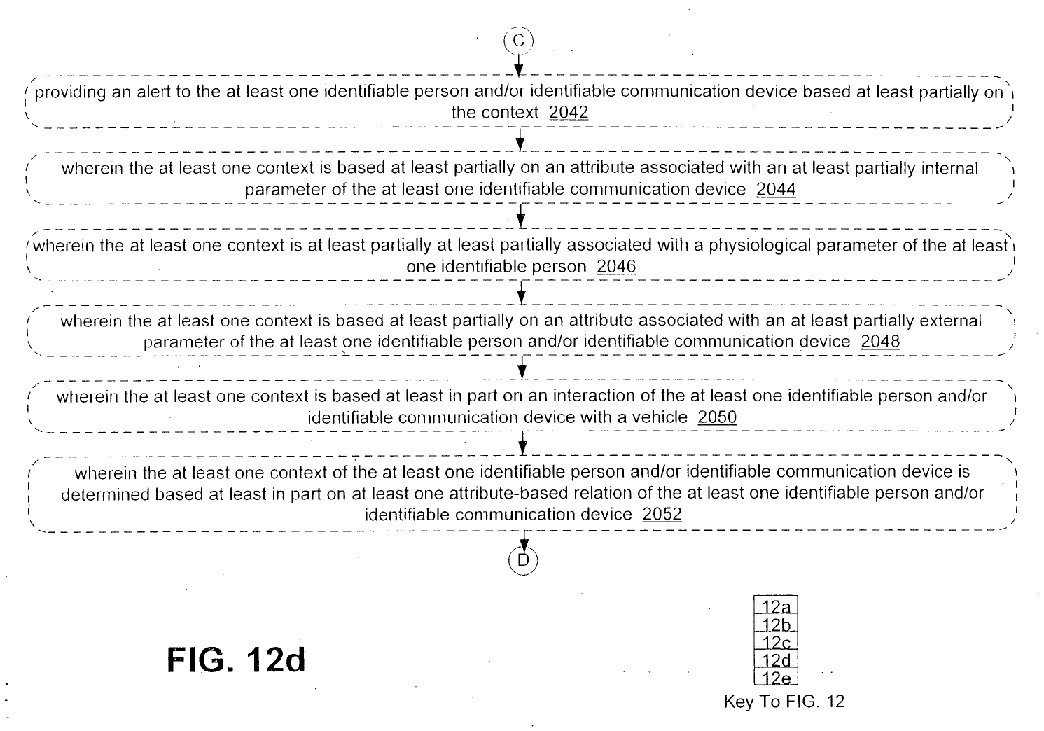

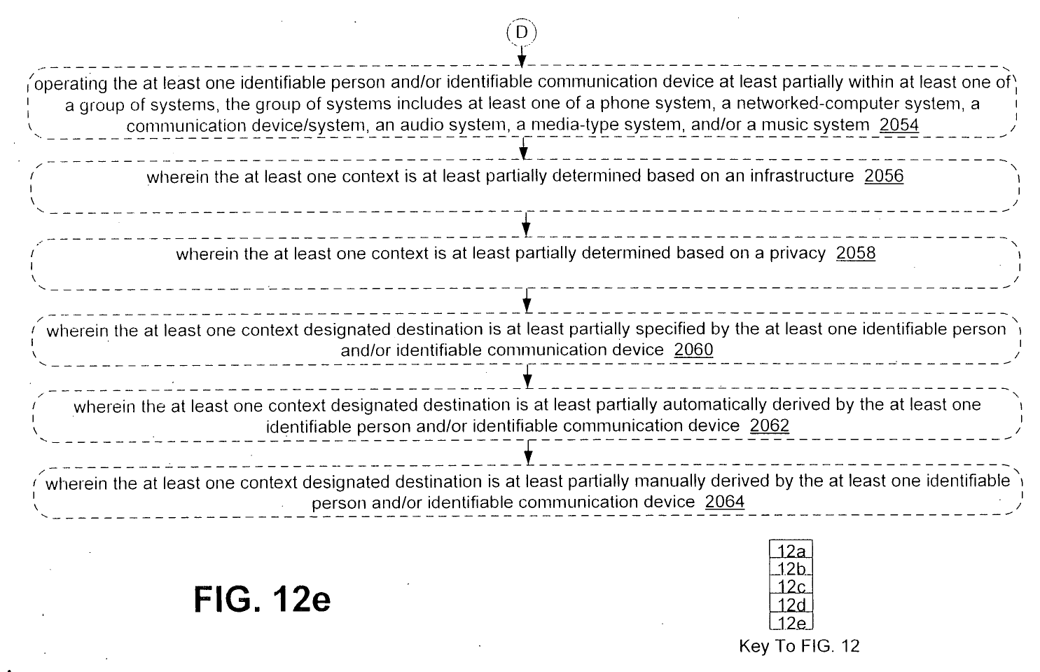

FIG. 12 (including FIGS. 12a, 12b, 12c, 12d, and/or 12c) shows certain embodiments of a context designated destination communication technique 2000 such as described with respect to, but not limited to, the context designated destination communication system 100 of FIGS. 1 to 10, and elsewhere in this disclosure. Certain embodiments of a high-level flowchart of the context designated destination communication technique 2000 can include, but is not limited to, optional operations 2010, 2012, 2014, 2016, 2017, 2018, 2020, 2022, 2024, 2026, 2028, 2030, 2032, 2034, 2036, 2038, 2040, 2042, 2044, 2046, 2048, 2050, 2052, 2054, 2056, 2058, 2060, 2062, and/or 2064. The high-level flowchart of FIG. 12 (including FIGS. 12a, 12b, 12c, 12d, and/or 12e) should be considered in combination with the embodiments of the context designated destination communication system 100, as described with respect to FIGS. 1 and 2, and elsewhere in this disclosure. Certain embodiments of operation 2002 can include, but is not limited to, associating an at least one identifiable person and/or identifiable communication device with an at least one context at least partially by specifying an at least one context designated destination that designates the at least one identifiable person and/or identifiable communication device based at least partially on the at least one context. For example, certain embodiments of the context associator 104 can associate the at least one identifiable person and/or identifiable communication device 108 with a context, such as by specifying the at least one context designated destination that designates the context of the at least one identifiable person and/or identifiable communication device 108. Certain embodiments of operation 2010 can include, but is not limited to, wherein the associating the at least one identifiable person and/or identifiable communication device with the at least one context is based at least in part on at least one location of the at least one identifiable person and/or identifiable communication device. For example, the associating the at least one identifiable person and/or identifiable communication device 108, can be based at least partially on the context, can be performed at least based on a location, such as within a physical structure, building, or dwelling, within a vehicle, contacting a person having a particular appearance or clothing at a particular location, etc. Certain embodiments of operation 2012 can include, but is not limited to, wherein the associating the at least one identifiable person and/or identifiable communication device with the at least one context is based at least in part on at least one movement of the at least one identifiable person and/or identifiable communication device. For example, the associating the at least one identifiable person and/or identifiable communication device 108, can be based at least partially on the context, can be performed at least based on a detected to sensed motion of the identifiable person and/or identifiable communication device 108, such as traveling in a vehicle along a particular roadway, contacting a person having a particular appearance or clothing traveling at a particular direction and/or a particular location (as may be sensed by GPS, other positional or motion detector, etc.). Certain embodiments of operation 2014 can include, but is not limited to, wherein the associating the at least one identifiable person and/or identifiable communication device with the at least one context is performed at least in part within or nearby at least a portion of at least one vehicle. For example, the associating the at least one identifiable person and/or identifiable communication device 108, can be based at least partially on the context, can be performed at least based on an association with a particular vehicle (that could travel along a roadway, airway, waterway, or other), such as to contacting a person associated with the particular vehicle, etc. Certain embodiments of operation 2016 can include, but is not limited to, wherein the associating the at least one identifiable person and/or identifiable communication device with the at least one context is performed at least in part within or nearby at least a portion of at least one business. For example, the associating the at least one identifiable person and/or identifiable communication device 108, can be based at least partially on the context, can be performed at least based on a business, an officer of that business, a division of the business, etc. As such, a person selected to represent the “context”of the business, division thereof, officer thereof, etc., may become “associated”, such as for some duration. Communications directed to that context may thereupon be transferred to the associated at least one identifiable person and/or identifiable communication device 108, as described in this disclosure. Certain embodiments of operation 2017 can include, but is not limited to, wherein the associating the at least one identifiable person and/or identifiable communication device with the at least one context is performed at least in part within or nearby at least a portion of at least one organization. For example, the associating the at least one identifiable person and/or identifiable communication device 108, can be based at least partially on the context, can be performed at least based on a business, an officer of that business, a division or portion of the business, etc. As such, a person selected to represent the “context” of the business, division thereof, officer thereof, etc., may become “associated”, such as for some duration. Communications directed to that context may thereupon be transferred to the associated at least one identifiable person and/or identifiable communication device 108, as described in this disclosure. Certain embodiments of operation 2018 can include, but is not limited to, wherein the associating the at least one identifiable person and/or identifiable communication device with the at least one context is performed at least in part within or nearby at least a portion of at least one defined space. For example, the associating the at least one identifiable person and/or identifiable communication device 108, can be based at least partially on the context, can be performed at least partially based on the at least one defined space, including but not limited to a physical structure, building, a dwelling, an office, etc. Certain embodiments of operation 2020 can include, but is not limited to, wherein the associating the at least one identifiable person and/or identifiable communication device with the at least one context is performed at least in part within or nearby at least a portion of at least one physical structure. For example, the associating the at least one identifiable person and/or identifiable communication device 108, can be based at least partially on the context, and can be performed at least partially based on the portion of the at least one physical structure, dwelling, etc. Certain embodiments of operation 2022 can include, but is not limited to, wherein the associating the at least one identifiable person and/or identifiable communication device with the at least one context is performed at least in part based on an action being performed by the at least one identifiable person and/or identifiable communication device. For example, certain embodiments of the identifiable person and/or identifiable communication device 108 can be configured to perform some action (e.g., such as with a computer-based or phone based menu, selector, etc.) such as to associate the at least one identifiable person and/or identifiable communication device 108 with the at least one context. Certain embodiments of operation 2024 can include, but is not limited to, wherein the associating the at least one identifiable person and/or identifiable communication device with the at least one context is based at least in part based on words or audio associated with the at least one identifiable person and/or identifiable communication device. For example, certain embodiments of the identifiable person and/or identifiable communication device 108 can be configured to provide some audio and/or words such as to associate the at least one identifiable person and/or identifiable communication device 108 with the at least one context. Certain embodiments of operation 2026 can include, but is not limited to, wherein the associating the at least one identifiable person and/or identifiable communication device with the at least one context is based at least in part on at least one temporal context. For example, certain embodiments of the identifiable person and/or identifiable communication device 108 can be configured to provide at least some temporal context (e.g., time of day, whether it is day, night, winter, summer, etc.) that can be used to associate the at least one identifiable person and/or identifiable communication device 108 with the context. For example, certain individuals can be associated with a context for a specific time slot, such as may be maintained using a computer program, a calendaring program, or other temporal context providing system such as may utilize hardware, software, and/or firmware aspects. Certain embodiments of operation 2028 can include, but is not limited to, wherein the associating the at least one identifiable person and/or identifiable communication device with the at least one context is performed at least in part based on at least one characteristic of at least one identifiable person and/or identifiable communication device. For example, certain embodiments of the context designated destination communication system 100 allows a person, who may want to call or otherwise communicate with a nearby, or other, person, organization, company, etc. Certain embodiments of operation 2030 can include, but is not limited to, connecting an at least one device to the at least one identifiable person and/or identifiable communication device based at least in part on the context. For example, certain embodiments of the interfacing person and/or interfacing communication device 110 can attempt to communicate with the at least one identifiable person and/or identifiable communication device 108, based at least partially on the context, as characterized by the context designated destination. Certain embodiments of operation 2032, further comprising translating from a relatively ambiguous specification to a relatively precise specification as associated with a device address of the at least one identifiable person and/or identifiable communication device, and wherein the associating the at least one identifiable person and/or identifiable communication device with the at least one context is performed at least partially in response to the translating from the relatively ambiguous specification to the relatively precise specification. For example, certain embodiments of the ambiguous specification can be associated with the at least one context designated destination. For example, the translating can include, but is not limited to, (e.g., translating who is in car, business, etc.) to phone number(s) of at least one identifiable person and/or identifiable communication device who indicated that they are in car, such as can be as stored in a database such as certain embodiments of the memory 97 of the context designated destination controller 97, certain embodiments of which are describe with respect to FIGS. 1 and 2, as well as other locations through this disclosure. Certain embodiments of operation 2034 can include, but is not limited to, wherein the associating the at least one identifiable person and/or identifiable communication device with the at least one context at least partially involves capturing an image of an identifiable person or object. For example, certain embodiments of the associating the at least one identifiable person and/or identifiable communication device 108 with the at least one context is associated with capturing as is generally known in imaging, visualization, and/or photography such that people can be at least partially associated with a context based at least partially by their appearance. Certain embodiments of operation 2036 can include, but is not limited to, wherein the associating the at least one identifiable person and/or identifiable communication device with the at least one context at least partially involves satisfying the at least one context. For example, certain embodiments of the associating the at least one identifiable person and/or identifiable communication device 108 with the at least one context is associated based at least partially on satisfying the context based on at least one of the identifiable person and/or identifiable communication device 108. Certain embodiments of operation 2038 can include, but is not limited to, wherein the at least one identifiable person and/or identifiable communication device includes at least one context-based designated destination communication mechanism and at least one addressing-based communication mechanism, and wherein the associating the at least one identifiable person and/or identifiable communication device with the at least one context is performed based at least in part on the at least one of the at least one context-based designated destination communication mechanism. For example, certain embodiments of the context designated destination communication system 100 can be configured to allow for communication via phones, radios, teleconferences, data-transfer, videos, etc. Such communication via a plurality of communication modalities may be particularly useful in emergency, warning, or other situations (e.g., floods, hurricanes, epidemic, etc.) such as to provide important information for persons in physical structure, dwellings, businesses, geographic locals, vehicles, etc. in particular regions. Certain embodiments of operation 2040 can include, but is not limited to, performing an at least one action at least partially using the at least one identifiable person and/or identifiable communication device based at least in part on the context. For example, certain embodiments of the context designated destination communication system 100 could be associated with at least one of the identifiable person and/or identifiable communication device 108 and/or the interfacing person and/or interfacing communication device 110, such as could perform some action such as for a fax machine, telephone ringer, etc. Certain embodiments of operation 2042 can include, but is not limited to, providing an alert to the at least one identifiable person and/or identifiable communication device based at least partially on the context. For example, an alert, warning, or an indication of an emergency or other condition can be provided to certain embodiments of the identifiable person and/or identifiable communication device 108 using certain embodiemnts of the context designated destination communication system 100. Certain embodimants of operation 2044 can include, but is not limited to, wherein the at least one context is based at least partially on an attribute associated with an at least partially internal parameter of the at least one identifiable communication device. For example, certain embodiments of the identifiable person and/or identifiable communication device 108 and/or the interfacing person and/or interfacing communication device 110 can rely at least partially on such internal detected information as positional-based or motion-based information (e.g., GPS or other positional-based or motion-based devices, thermometers, condition sensors, etc.). Certain embodiments of operation 2046 can include, but is not limited to, wherein the at least one context is at least partially at least partially associated with a physiological parameter of the at least one identifiable person. For example, certain embodiments of the identifiable person and/or identifiable communication device 108 and/or the interfacing person and/or interfacing communication device 110 can be configured to sense a state, condition, or other physiological parameter of at least one of the persons associated therewith. Certain embodiments of operation 2048 can include, but is not limited to, wherein the at least one context is based at least partially on an attribute associated with an at least partially external parameter of the at least one identifiable person and/or identifiable communication device. For example, certain embodiments of the context designated destination communication system 100 can rely on a context that can be detected based at least partially on an attribute that is external of the identifiable person and/or identifiable communication device 108 and/or the interfacing person and/or interfacing communication device 110. For instance, as certain embodiments of the interfacing person and/or interfacing communication device 110 and/or the identifiable person and/or identifiable communication device 108 approach a toll booth, or are pulled over by police, it may be possible for the police or other person to effectively turn down volume of radio in a vehicle. As such, the police or toll collector, etc., could effectively turn down volumes of all radios, etc, in the cars (even those radios, etc. that are personal, such as IPODs). Certain embodiments of operation 2050 can include, but is not limited to, wherein the at least one context is based at least in part on an interaction of the at least one identifiable person and/or identifiable communication device with a vehicle. For example, certain embodiments of the at least one identifiable person and/or identifiable communication device 108 and/or interfacing person and/or interfacing communication device 110 can be configured to be manually, or automatically, actuated when they enter a car, a home, a business, etc. As such, the device(s) can assume a number of addresses. Certain embodiments of the identifiable person and/or identifiable communication device 108 and/or interfacing person and/or interfacing communication device 110 can be configured where the at least one context is selectable by a particular phone, etc. Certain embodiments of the context designated destination communication system 100 can thereby be applied to computer-based system and phone type system. Certain embodiments of the context can include that two people are interacting (e.g., doctor-patient, buyer-seller, family members, professional relationships, etc.). Certain embodiments of the communication device can thereby recognizes that two people are in close proximity, and thereupon recognizes what characteristics they have in common and brings up a menu based on shared user attributes. Certain embodiments of operation 2052 can include, but is not limited to, wherein the at least one context of the at least one identifiable person and/or identifiable communication device is determined based at least in part on at least one attribute-based relation of the at least one identifiable person and/or identifiable communication device. For example, a variety of attribute-based relation can be provided such that the context identifier 102 can operate based at least partially on the at least one context configured to obtain the at least one context designated destination based at least in part on the at least one context (or location, such as positioning) of the moveable phone. Certain embodiments of an attribute-based relation can include, but are not limited to, proximity structure such as being near, above, far from, next to, etc. Additionally, certain attributes can include at least one of command structure (subordinate, boss, peer, etc.), social network (friend, friend of friend, network member, clan member, group member, etc.), item attributes (own same item, own item with similar attributes, etc.; e.g. “a shift like that” or “a shirt like his”, etc.). Certain embodiments of an attribute-based relation can include, but are not limited to: “older than”, in same room with”, “having shoes of the same brand”, “having a more capable phone”, “having a device with the same OS”, “his son”, “someone in the same family”, etc. Certain embodiments of an attribute-based relation can include, but are not limited to for patient/heath care provider instances, privacy requirements of user and device privacy if connected to, etc. Certain embodiments of operation 2054 can include further comprising operating the at least one identifiable person and/or identifiable communication device at least partially within at least one of a group of systems, the group of systems includes at least one of a phone system, a networked-computer system, a communication device/system, an audio system, a media-type system and/or a music system. For example, certain embodiments of the context designated destination communication system 100 can utilize such examples of systems for communication. Certain embodiments of operation 2056 can include, but is not limited to, wherein the at least one context is at least partially determined based on an infrastructure. For example, certain embodiments of the context designated destination communication system 100 can rely on the context which is at least partially based on signal characteristics, infrastructure component proximity/engagement (e.g. which tower or antenna is nearest), component relationship (e.g. what subnet a device is on), etc. This may be novel because we are not interested in these things per se (e.g. what node something is connected to) but in inferring context from it (e.g., of it's on node X, it must be in that car or in that room, or owned by Joe, etc.). Certain embodiments of operation 2058 can include, but is not limited to, wherein the at least one context is at least partially determined based on a privacy. For example, certain users of certain embodiments of the identifiable person and/or identifiable communication device 108 and/or the interfacing person and/or interfacing communication device 110 can determine whether they wish to receive various types of communications such as those from/to/with certain persons. Additionally, certain embodiments of the context designated destination communication system 100 can provide a variety of context-based information that may not be wished to be detected, such as to allow communication on a private topic which is not desired to publicize (e.g., a person utilizing their identifiable person and/or identifiable communication device 108 and/or interfacing person and/or interfacing communication device 110 to locate the nearest bathroom). Certain embodiments of operation 2060 can include, but is not limited to, wherein the at least one context designated destination is at least partially specified by the at least one identifiable person and/or identifiable communication device. For example, certain embodiments of at least one identifiable person and/or identifiable communication device 108 and/or interfacing person and/or interfacing communication device 110 can specify the at least one context designated destination. Certain embodiments of operation 2062 can include, but is not limited to, wherein the at least one context designated destination is at least partially automatically derived by the at least one identifiable person and/or identifiable communication device. For example, certain embodiments of the at least one context designated destination of the identifiable person and/or identifiable communication device 108 can be automatically derived, such as may occur flowing detection be a detector, sensor, or other device when a persons approaches a building, office, vehicle, etc. Certain embodiments of operation 2064 can include, but is not limited to, wherein the at least one context designated destination is at least partially manually derived b)l the at least one identifiable person and/or identifiable communication device. For example, certain embodiments of the at least one context designated destination of the identifiable person and/or identifiable communication device 108 can be manually derived, such as may occur flowing detection be a detector, sensor, or other device when a persons approaches a building, office, vehicle, etc. The order of the operations, methods, mechanisms, etc. as described with respect to FIG. 12 (including FIGS. 12a, 12b, 12c, 12d, and/or 12e) is intended to be illustrative in nature, and not limited in scope.

In one or more various aspects, related systems include but are not limited to circuitry and/or programming for effecting the herein-referenced method aspects; the circuitry and/or programming can be virtually any combination of hardware, software, electromechanical system, and/or firmware configurable to effect the herein—referenced method aspects depending upon the design choices of the system designer.

### 6. Conclusion

This disclosure provides a number of embodiments of the context designated destination communication system 100. The embodiments of the context designated destination communication system as described with respect to this disclosure are intended to be illustrative in nature, and are not limiting its scope.

Those having skill in the art will recognize that the state of the art in computer, controller, interfacings, networking, and other similar technologies has progressed to the point where there is little distinction left between hardware, firmware, and/or software implementations of aspects of systems, such as may be utilized in the context designated destination communication system. The use of hardware, firmware, and/or software can therefore generally represent (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle can vary with the at least one context in which the processes and/or systems and/or other technologies are deployed. For example, if an implementer determines that speed and accuracy are paramount, the implementer and/or designer of the context designated destination communication system may opt for mainly a hardware and/or firmware vehicle. In alternate embodiments, if flexibility is paramount, the implementer and/or designer may opt for mainly a software implementation. In yet other embodiments, the implementer and/or designer may opt for some combination of hardware, software, and/or firmware. Hence, there are several possible techniques by which the processes and/or devices and/or other technologies described herein may be effected, none of which is inherently superior to the other in that any vehicle to be utilized is a choice dependent upon the at least one context in which the vehicle can be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, target person or computer, and/or collectively, by a wide range of hardware, software, firmware, or virtually any combination thereof. In Certain embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs ruling on one or more computers such as communication device, such as may at least partiality utilize microprocessors, firmware, software, hardware, or as virtually any combination thereof. Designing the circuitry and/or writing the code for the hardware, software, and-or firmware is generally understood and would be well understood within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog interfacing links using TDM or IP based interfacing links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

It is to be understood by those skilled in the art that, in general, that the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term ” includes” should be interpreted as “includes, but is not limited to”; etc. In this disclosure and the appended claims, the terms “a”, “the”, and “at least one” positioned prior to one or more goods, items, and/or services are intended to apply inclusively to either one or a plurality of those goods, items, and/or services.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-30. (canceled)

31. An apparatus, comprising:
an at least one identifiable person and/or identifiable communication device configured to associate an at least one context designated destination that designates an at least one context of the at least one identifiable person and/or identifiable communication device.

32. The apparatus of claim 31, wherein the at least one identifiable person and/or identifiable communication device is configured to associate the at least one context designated destination at least in part based on at least one location of the at least one identifiable person and/or identifiable communication device.

33. The apparatus of claim 31, wherein the at least one identifiable person and/or identifiable communication device is configured to associate the at least one context designated destination at least in part based on at least one movement of the at least one identifiable person and/or identifiable communication device.

34. The apparatus of claim 31, wherein the at least one identifiable person and/or identifiable communication device is configured to associate the at least one context designated destination at least in part within or nearby at least a portion of at least one vehicle.

35. The apparatus of claim 31, wherein the at least one identifiable person and/or identifiable communication device is configured to associate the at least one context designated destination at least in part within or nearby at least a portion of at least one business.

36. The apparatus of claim 31, wherein the at least one identifiable person and/or identifiable communication device is configured to associate the at least one context designated destination at least in part within or nearby at least a portion of at least one organization.

37. The apparatus of claim 31, wherein the at least one identifiable person and/or identifiable communication device is configured to associate the at least one context designated destination at least in part within or nearby at least a portion of at least one defined space.

38. The apparatus of claim 31, wherein the at least one identifiable person and/or identifiable communication device is configured to associate the at least one context designated destination at least partially within or nearby at least a portion of at least one physical structure.

39. The apparatus of claim 31, wherein the at least one identifiable person and/or identifiable communication device is configured to associate the at least one context designated destination at least partially based on the at least one identifiable person and/or identifiable communication device performing an action.

40. The apparatus of claim 31, wherein the at least one identifiable person and/or identifiable communication device is configured to associate the at least one context designated destination at least in part based on words or audio associated with the at least one identifiable person and/or identifiable communication device.

41. The apparatus of claim 31, wherein the at least one identifiable person and/or identifiable communication device is configured to associate the at least one context designated destination is based at least in part on at least one temporal context.

42. The apparatus of claim 31, wherein the at least one identifiable person and/or identifiable communication device is configured to associate the at least one context designated destination at least in part based on at least one characteristic of at least one identifiable person and/or identifiable communication device.

43. The apparatus of claim 31, further comprising:
the at least one identifiable person and/or identifiable communication device configured to operatively couple to another device based at least in part on the context.

44. The apparatus of claim 31, further comprising the at least one identifiable person and/or identifiable communication device configured to translate from a relatively ambiguous specification to a relatively precise specification as associated with a device address, as performed at least partially in response to the translating from the relatively ambiguous specification to the relatively precise specification.

45. The apparatus of claim 31, wherein the at least one identifiable person and/or identifiable communication device configured to associate with the at least one context at least partially involves capturing an image of an identifiable person or object.

46. The apparatus of claim 31, wherein the at least one identifiable person and/or identifiable communication device configured to associate with the at least one context at least partially involves satisfying the at least one context.

47. The apparatus of claim 31, wherein the at least one identifiable person and/or identifiable communication device is configured to associate with the at least one context including a plurality of communication modalities, and wherein the associating the at least one identifiable person and/or identifiable communication device with the at least one context is performed based at least in part on the at least one of the plurality of communication modalities.

48. The apparatus of claim 31, further comprising:
the at least one identifiable person and/or identifiable communication device configured to perform some action based at least in part on the context.

49. The apparatus of claim 31, further comprising:
the at least one identifiable person and/or identifiable communication device configured to provide an alert based at least partially on the context.

50. The apparatus of claim 31, wherein the at least one context is based at least partially on a physiological parameter of the at least one identifiable person.

51. The apparatus of claim 31, wherein the at least one context is based at least partially on an attribute associated with an at least partially external parameter of the at least one identifiable person and/or identifiable communication device.

52. The apparatus of claim 31, wherein the at least one context is based at least in part on an interaction of the at least one identifiable person and/or identifiable communication device with a vehicle.

53. The apparatus of claim 31, wherein the at least one context of the at least one identifiable person and/or identifiable communication device is determined based at least in part on at least one attribute-based relation of the at least one identifiable person and/or identifiable communication device.

54. The apparatus of claim 31, further comprising operating the at least one identifiable person and/or identifiable communication device at least partially within at least one of a group of systems, the group of systems includes a phone system, a networked-computer system, a communication device/system, an audio system, a media-type system, and/or a music system.

55. The apparatus of claim 31, wherein the at least one context is at least partially determined based on an infrastructure.

56. The apparatus of claim 31, wherein the at least one context is at least partially configured to ensure a privacy of an infrastructure.

57. The apparatus of claim 31, wherein the at least one context designated destination is at least partially specified by the at least one identifiable person and/or identifiable communication device.

58. The apparatus of claim 31, wherein the at least one identifiable person and/or identifiable communication device at least partially automatically derives the at least one context designated destination.

59. The apparatus of claim 31, wherein the at least one identifiable person and/or identifiable communication device at least partially manually derives the at least one context designated destination.

60. An apparatus, comprising:
an at least one identifiable person and/or identifiable communication device configured to receive at least one communication request directed at least in part based on an at least one context of the at least one identifiable person and/or identifiable communication device.

61. The apparatus of claim 60, wherein the at least one identifiable person and/or identifiable communication device at least partially automatically receives the at least one communication.

62. The apparatus of claim 60, wherein the at least one identifiable person and/or identifiable communication device at least partially manually receives the at least one communication.
